(19) United States
(12) Patent Application Publication
(10) Pub. No.: US 2026/0312498 A1
(43) Pub. Date: Oct. 8, 2026

(54) METHODS AND APPARATUS TO PHASE SHED A MULTI-PHASE VOLTAGE REGULATOR

(71) Applicant: Texas Instruments Incorporated, Dallas, TX (US)

(72) Inventors: Preetam Charan Anand Tadeparthy, Bangalore (IN); Vikas Lakhanpal, Bangalore (IN); Vikram Gakhar, Bangalore (IN); Kevin Clark La Rosa, Sachse, TX (US); Sreelakshmi S, Bangalore (IN); Matthew John Ascher Schurmann, Wylie, TX (US)

(21) Appl. No.: 19/222,643

(22) Filed: May 29, 2025

Related U.S. Application Data
(60) Provisional application No. 63/655,801, filed on Jun. 4, 2024.

(51) Int. Cl. H02M 3/158; H02M 1/00

(52) U.S. Cl. CPC H02M 3/1586; H02M 1/0009; H02M 1/0019

(57) ABSTRACT

An example apparatus includes: current monitor circuitry capable of determining a power consumption; pulse width modulation (PWM) generation circuitry capable of generating a plurality of PWM signals having different phases; and dropout circuitry coupled to the current monitor circuitry and the PWM generation circuitry, the dropout circuitry capable of: generating a dropout order of the plurality of PWM signals; detecting a rotation event using the power consumption; and adjusting the dropout order of the plurality of PWM signals responsive to the rotation event.

### CROSS-REFERENCE TO RELATED APPLICATION

This patent application claims the benefit of and priority to U.S. Provisional Patent Application No. 63/655,801 filed Jun. 4, 2024, which is hereby incorporated herein by reference in its entirety.

### TECHNICAL FIELD

This description relates generally to power conversion and, more particularly, to methods and apparatus to phase shed a multi-phase voltage regulator.

### BACKGROUND

Power supply systems provide a reliable supply of power to a device. Some power supplies include a voltage regulator (also referred to as a converter) to supply a voltage by regulating power from another source. An alternating current (AC) to direct current (DC) regulator provides a DC voltage by regulating power from an AC power supply. A DC-to-DC regulator regulates a first DC voltage to produce a second DC voltage. In some devices, a voltage regulator boosts a voltage to produce a higher voltage. In other devices, a voltage regulator bucks a voltage to produce a lower voltage. Power supply systems use regulator circuitry to power devices efficiently.

For methods and apparatus to phase shed a multi-phase voltage regulator, an example apparatus includes current monitor circuitry capable of determining a power consumption; pulse width modulation (PWM) generation circuitry capable of generating a plurality of PWM signals having different phases; and dropout circuitry coupled to the current monitor circuitry and the PWM generation circuitry, the dropout circuitry capable of: generating a dropout order of the plurality of PWM signals; detecting a rotation event using the power consumption; and adjusting the dropout order of the plurality of PWM signals responsive to the rotation event. Other examples are described.

For methods and apparatus to phase shed a multi-phase voltage regulator, an example apparatus includes a first power stage; a second power stage; and a controller coupled to the first power stage and the second power stage, the controller capable of: sensing a power supply by the first power stage and the second power stage; comparing the power supplied by the first power stage and the second power stage to a threshold; disabling the first power stage based on a dropout order responsive to the comparison; and adjusting the dropout order responsive to power supplied by the first power stage and the second power stage. Other examples are described.

For methods and apparatus to phase shed a multi-phase voltage regulator, an example apparatus includes pulse width modulation (PWM) generation circuitry capable of generating a first group of PWM signals and a second group of PWM signals; and dropout circuitry coupled to the PWM generation circuitry, the dropout circuitry capable of: generating a first dropout order of the first group of PWM signals; generating a second dropout order of the second group of PWM signals; adjusting the first dropout order of the first group of PWM signals responsive to a rotation event; and adjusting the second dropout order of the second group of PWM signals responsive to a rotation event. Other examples are described.

### BRIEF DESCRIPTION OF THE DRAWINGS

FIG. 1 is a block diagram of an example processing system including example multi-phase voltage regulator circuitry.

FIG. 2 is a schematic diagram of an example of the multi-phase voltage regulator circuitry of FIG. 1 including an example controller and a plurality of power stages.

FIG. 3 is a block diagram of an example of the controller of FIG. 2 including example phase shedding (PS) dropout circuitry.

FIGS. 4A, 4B, 4C, and 4D are plots of example operations of the controller of FIGS. 2 and 3.

FIG. 5 is a flowchart representative of example machine-readable instructions or example operations that may be at least one of executed, instantiated, or performed using an example implementation of the controller of FIGS. 2 and 3 or, more generally, the multi-phase voltage regulator circuitry of FIGS. 1 and 2.

FIG. 6 is a timing diagram of an example rotation of a dropout order of the multi-phase voltage regulator circuitry across multiple rotation events.

FIG. 7 is a schematic diagram of another example of the multi-phase voltage regulator circuitry of FIGS. 1 and 2 including an example trans-inductor voltage regulator (TLVR) partition.

FIG. 8 is a schematic diagram of another example of the multi-phase voltage regulator circuitry of FIGS. 1, 2, and 7 including a first group of power stages and a second group of power stages.

FIG. 9 is a flowchart representative of example machine-readable instructions or example operations that may be at least one of executed, instantiated, or performed using an example implementation of the multi-phase voltage regulator circuitry of FIGS. 1 and 8 including the first and second groups of FIG. 8.

FIG. 10 is a timing diagram of an example rotation of a first dropout order of the first group and a second dropout order of the second group.

FIG. 11 is a schematic diagram of another example of the multi-phase voltage regulator circuitry of FIGS. 1, 2, 7, and 8 including another example of first and second groups of FIG. 8.

FIG. 12 is a schematic diagram of another example of the multi-phase voltage regulator circuitry of FIGS. 1, 2, 7, 8, and 11 including a first TLVR partition and a second TLVR partition, the TLVR partitions corresponding to a respective group of power stages.

FIG. 13 is a flowchart representative of example machine-readable instructions or example operations that may be at least one of executed, instantiated, or performed using an example implementation of the multi-phase voltage regulator circuitry of FIGS. 1, 11, and 12 including the first and second groups of FIGS. 11 and 12.

FIG. 14 is a timing diagram of an example rotation of a first dropout order of the first group of FIGS. 11 and 12 and a second dropout order of power stages of FIGS. 11 and 12.

FIG. 15 is a block diagram of an example processing platform including programmable circuitry structured to execute, instantiate, or perform the example machine-readable instructions or perform the example operations of FIGS. 5, 9, and 13 to implement the controller 240 of FIGS. 2, 3, 7, 8, 11, and 12.

FIG. 16 is a block diagram of an example implementation of the programmable circuitry of FIG. 15.

FIG. 17 is a block diagram of another example implementation of the programmable circuitry of FIG. 15.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Power supply systems provide a reliable supply of power to a device. Some power supplies include a voltage regulator (also referred to as a converter) to supply a voltage by regulating power from another source. An alternating current (AC) to direct current (DC) regulator provides a DC voltage by regulating power from an AC power supply. A DC-to-DC regulator regulates a first DC voltage to produce a second DC voltage. In some devices, a voltage regulator boosts a voltage to produce a higher voltage. In other devices, a voltage regulator bucks a voltage to produce a lower voltage. Power supply systems use regulator circuitry to efficiently power devices.

Multi-phase voltage regulators are DC-to-DC regulators that convert DC voltage from a first level to a second level. Multi-phase voltage regulator circuitry includes multiple power stages, an inductor-capacitor (LC) filter, and a controller. The power stages receive a first supply voltage (VDD) and operate based on multiple phase shifted PWM signals to produce a desired DC voltage. The power stages regulate a supply of current to inductors of the LC filter based on the PWM signals.

In operation, the LC filter includes multiple inductors that receive current from the power stages. The capacitor of the LC filter produces a voltage (VCC) at an output of the multi-phase voltage regulator using currents from the inductors. In some examples, the LC filter is a low pass filter, which filters relatively high-speed changes of the voltage (VCC) at the output of the multi-phase voltage regulator. Also, the capacitor of the LC filter may decouple the power stages from a load coupled to the output of the multi-phase voltage regulator. In such operations, the LC filter provides the voltage (VCC) at the output of the multi-phase voltage regulator. The current at the output of the multi-phase voltage regulator is set by the number of power stages supplying current to the inductors of the LC filter. In some devices, the multi-phase voltage regulator bucks the supply voltage (VDD) to produce a lower voltage (VCC) with a higher current. Such a voltage (VCC) at the output of the multi-phase voltage regulator supports low voltage devices, such as high-speed transistor switching, solid-state memory, processors, etc.

In operation, the controller generates multiple PWM signals to drive the power stages. In some examples, the PWM signals have a relatively short duty cycle (e.g., 5 %, 10 %, 15 %, 20 %, etc.). The controller phase shifts each of the PWM signals to sequence a supply of current by the power stages. For example, if the controller generates three PWM signals to control three power stages, the controller generates a first PWM signal with a zero-degree phase shift, a second PWM signal with a one-hundred and twenty degree phase shift, and a third PWM signal with a two-hundred and forty degree phase shift. A first power stage, which receives the first PWM signal, supplies power to the LC filter during a first time. A second power stage, which receives the second PWM signal, supplies power to the to the LC filter during a second time. A third power stage, which receives the third PWM signal, supplies power to the LC filter during a third time. In such example operations, the duty cycles of the PWM signals are set to prevent the first, second, and third times from overlapping.

Some multi-phase voltage regulators support phase shedding to conserve power when the power consumption of a load decreases. In such devices, the power stages provide current sense signals (CS_N) to the controller. The current sense signals represent currents at the output of the power stages. The controller determines a power consumption of a load using the current sense signals. The controller compares the power consumption to reference levels, which correspond to power supplied by different numbers of power stages. For example, a first reference level represents the supply of power by a single power stage. A second reference level represents the supply of power by two power stages, etc. During power shedding, the controller drops (e.g., disable, turn off, set to a fixed state, etc.) PWM signals and corresponding power stages responsive to a determination that the power consumption by a load can be satisfied by fewer power stages. The controller continues to shed (e.g., drop additional signals) PWM signals to further drop additional power stages as the power consumption continues to decrease. Phase shedding increases power efficiency by reducing the supply of power by the multi-phase voltage regulator to match the power consumption of a load.

However, turning off the power stages during phase shedding unevenly ages components of different power stages. For example, in processing systems, the multi-phase voltage regulator always keeps at least one power stage active to provide a minimum power to a processor. Such a condition of the processing system is referred to as idle. In idle, the processing system waits for a workload to execute. In such examples, the idle time may be substantially longer than the time in which a workload is being executed. For example, the processing system may execute a workload in ten seconds after waiting several minutes in an idle state. In such conditions, the power stage that remains active during the idle state ages substantially more than the power stages that are off during idle. Such uneven operating times of the power stages results in mismatches, which decreases reliability.

Examples described herein include methods and apparatus to phase shed a multi-phase voltage regulator by adjusting a dropout order of power stages. In some described examples, the multi-phase voltage regulator includes multiple power stages, an LC filter, and a controller, which further includes phase shedding (PS) dropout circuitry. In such examples, the PS dropout circuitry generates a dropout order for the power stages during phase shedding. The dropout order is a sequential list of the PWM signals or corresponding power stages. In some examples, the PWM signal or power stage(s) at the top of the list is the last to dropout during phase shedding. Alternatively, the PWM signal or power stage(s) at the bottom of the list are the first to dropout during phase shedding. As such, during phase shedding, the controller determines which PWM signal to drop using the dropout order.

In example operations, the PS dropout circuitry adjusts the dropout order responsive to a rotation event. In some examples, the PS dropout circuitry uses a first-in first-out (FIFO) queue to track the dropout order. For example, the PS dropout circuitry shifts the PWM signal or power stage at the top of the dropout order to the bottom of dropout order. In such examples, the PWM signal or power stage that remains active (e.g., is the last to dropout) prior to a rotation event is the first PWM signal or power stage to dropout (e.g., be turned off) after the rotation event. Alternatively, another queue or method of rotation may be implemented using this description. Advantageously, rotating the dropout order distributes the aging of the power stages during phase shedding operations. Advantageously, evenly aging components of the power stages increase reliability.

In such example operations, the PS dropout circuitry generates rotation events responsive to conditions of the multi-phase voltage regulator. For example, the PS dropout circuitry generates a rotation event when power consumption by the load decreases below a threshold. In another example, the PS dropout circuitry waits for a condition, such as the power consumption decreasing below the threshold, to occur a plurality of times before generating a rotation event. In yet another example, the PS dropout circuitry generates a rotation event periodically to continue to rotate the dropout order. Alternatively, the PS dropout circuitry may use an alternative condition of the multi-phase voltage regulator to generate a rotation event. Advantageously, the PS dropout circuitry can rotate the dropout order responsive to different aging considerations of the multi-phase voltage regulator.

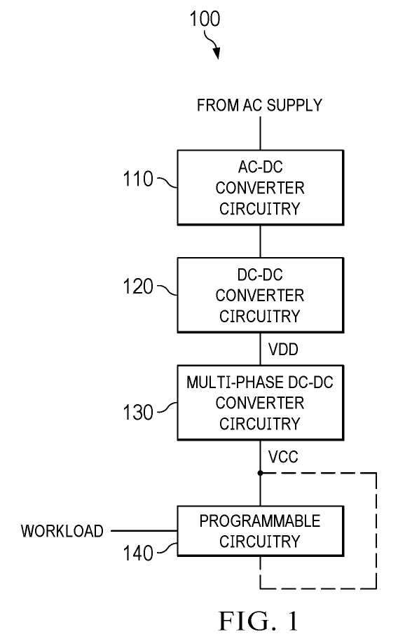

FIG. 1 is a block diagram of an example processing system 100. The example processing system 100 of FIG. 1 includes example AC-DC regulator circuitry 110, example DC-DC regulator circuitry 120, example multi-phase voltage regulator circuitry 130, and example programmable circuitry 140.

The processing system 100 receives power from an AC supply, such as a grid connection via an outlet. The processing system 100 receives a workload from an external source. The processing system 100 executes machine readable instructions to instantiate circuitry to perform the operations of the workload using power from the AC supply. However, before using power from the AC supply, the processing system 100 regulates the supply of power to provide a relatively low voltage (VCC) to the programmable circuitry 140.

The AC-DC regulator circuitry 110 has an input and an output. The input of the AC-DC regulator circuitry 110 is structured to be coupled to an AC power supply. For example, a grid connection or an outlet provides power using a one-hundred and twenty volt (V) AC signal having a frequency of sixty hertz (Hz). The output of the AC-DC regulator circuitry 110 is coupled to the DC-DC regulator circuitry 120. The AC-DC regulator circuitry 110 provides a DC voltage by converting the AC signal from the AC power supply.

The DC-DC regulator circuitry 120 has an input and an output. The input of the DC-DC regulator circuitry 120 is coupled to the AC-DC regulator circuitry 110. The output of the DC-DC regulator circuitry 120 is coupled to the multi-phase voltage regulator circuitry 130. The DC-DC regulator circuitry 120 steps down the DC voltage from the AC-DC regulator circuitry 110 to produce a lower DC voltage (VDD). The DC-DC regulator circuitry 120 provides the lower DC voltage (VDD) to the multi-phase voltage regulator circuitry 130.

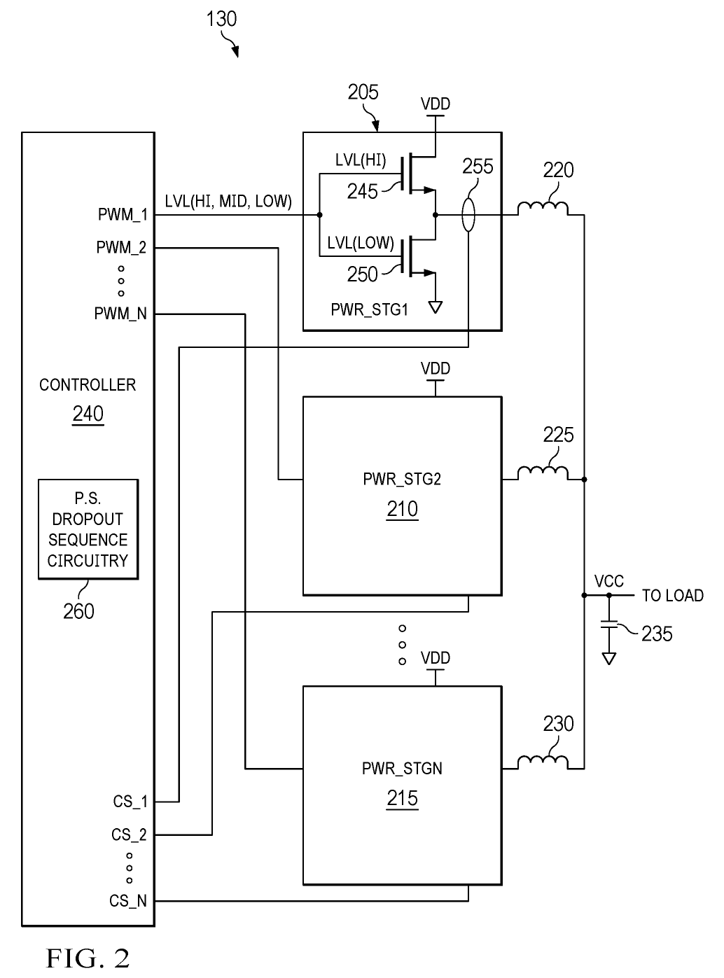

The multi-phase voltage regulator circuitry 130 has an input and an output. The input of the multi-phase voltage regulator circuitry 130 is coupled to the DC-DC regulator circuitry 120. The output of the multi-phase voltage regulator circuitry 130 is coupled to the programmable circuitry 140. The multi-phase voltage regulator circuitry 130 converts the DC voltage (VDD) from the DC-DC regulator circuitry 120 to produce a lower DC voltage (VCC) having a relatively high current. The multi-phase voltage regulator circuitry 130 provides the lower DC voltage (VCC) to the programmable circuitry 140. Examples of the multi-phase voltage regulator circuitry 130 are further illustrated and described in connection with FIGS. 2, 7, 8, 11, and 12.

The programmable circuitry 140 is coupled to the multi-phase voltage regulator circuitry 130, which provides the DC supply (VCC). The programmable circuitry 140 is structured to be communicatively coupled to an external source, which provides a workload for execution. The programmable circuitry 140 uses power from the multi-phase voltage regulator circuitry 130 to execute the workload. The programmable circuitry 140 provides the result of executing the workload to the external source.

In example operations of the processing system 100, the AC-DC regulator circuitry 110 converts an AC signal from an AC source (e.g., the grid) to supply a relatively high DC voltage. For example, the AC-DC regulator circuitry 110 produces a forty-volt (V) DC voltage responsive to receiving a one-hundred and twenty-volt (V) AC signal. The DC-DC regulator circuitry 120 bucks (e.g., steps down) the relatively high DC voltage to produce a lower DC voltage (VDD). For example, the DC-DC regulator circuitry 120 produces a twelve-volt (V) DC voltage responsive to receiving the forty-volt DC voltage from the AC-DC regulator circuitry 110. The multi-phase voltage regulator circuitry 130 regulates the DC voltage (VDD) from the DC-DC regulator circuitry 120 to produce a lower DC voltage (VCC) with a relatively high current. For example, the multi-phase voltage regulator circuitry 130 produces a two-volt (V) DC voltage responsive to receiving the twelve volt (V) DC voltage from the DC-DC regulator circuitry 120.

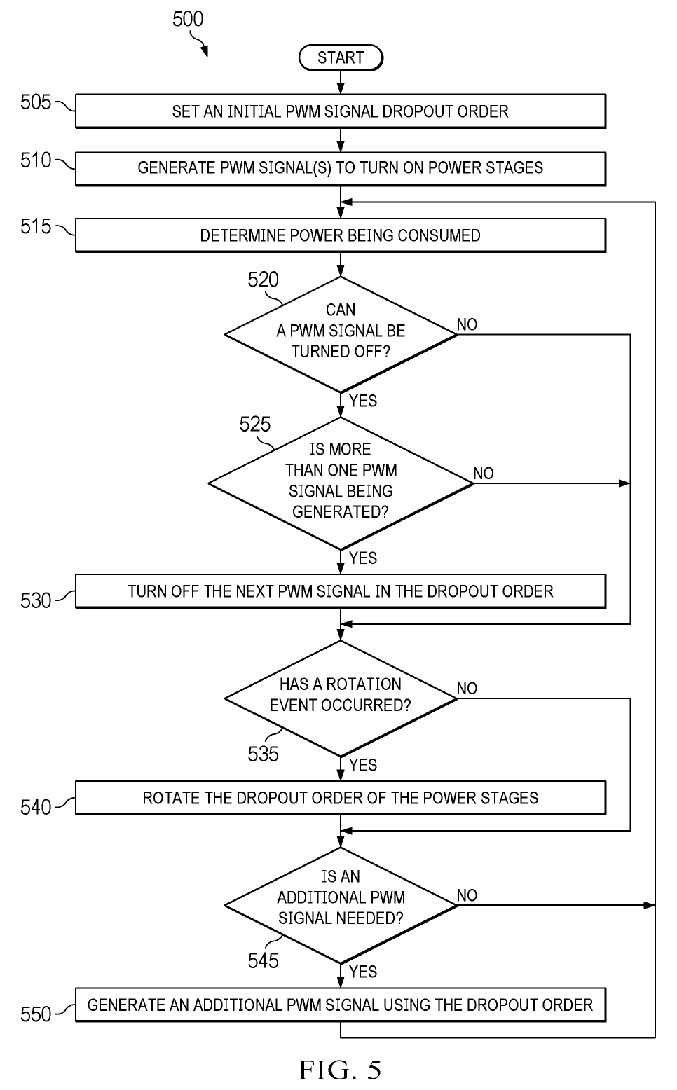

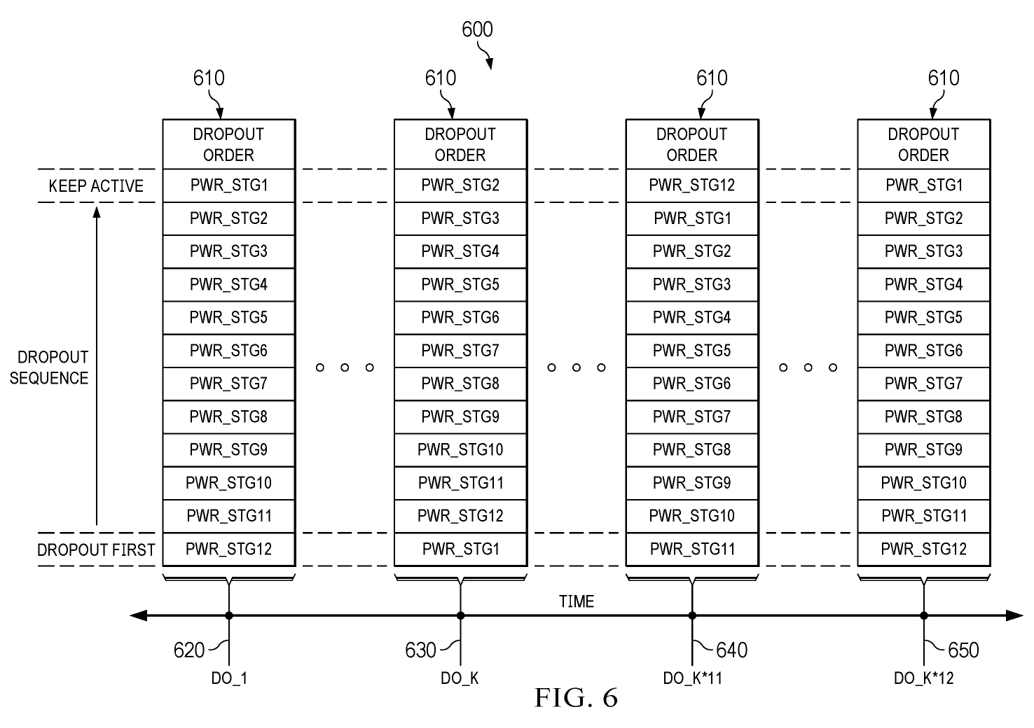

In some example operations, the multi-phase voltage regulator circuitry 130 adjusts a current of the DC voltage (VCC) responsive to the power consumption of the programmable circuitry 140. For example, if the programmable circuitry 140 is executing a workload, the multi-phase voltage regulator circuitry 130 provides a maximum current. In another example, if the programmable circuitry 140 is waiting for another workload, the multi-phase voltage regulator circuitry 130 implements phase shedding to reduce the current. The multi-phase voltage regulator circuitry 130 uses a dropout order to sequence phase shedding different power stages. In such example operations, the multi-phase voltage regulator circuitry 130 rotates the dropout order responsive to a rotation event. Example operations of the multi-phase voltage regulator circuitry 130 are further illustrated and described in connection with FIGS. 6, 10, and 14. Advantageously, rotating the dropout order of components of the multi-phase voltage regulator circuitry 130 distributes the stress and aging across the multi-phase voltage regulator circuitry 130. Example operations of the multi-phase voltage regulator circuitry 130 are further illustrated and described in connection with FIG. 2 and the flowchart of FIG. 5.

FIG. 2 is a schematic diagram of an example of the multi-phase voltage regulator circuitry 130 of FIG. 1. In the example of FIG. 1, the multi-phase voltage regulator circuitry 130 includes a first power stage 205, a second power stage 210, a third power stage 215, a first inductor 220, a second inductor 225, a third inductor 230, a capacitor 235, and a controller 240. The example power stage 205 of FIG. 2 includes a first example transistor 245, a second example transistor 250, and an example current sensor 255. The example controller 240 of FIG. 2 includes example phase shedding (PS) dropout circuitry 260. Although in the example of FIG. 2, the multi-phase voltage regulator circuitry 130 includes three power stages, the multi-phase voltage regulator circuitry 130 may be modified to include any number of power stages.

The multi-phase voltage regulator circuitry 130 has an input and an output. The input of the multi-phase voltage regulator circuitry 130 is structured to be coupled to a DC power supply, such as the DC-DC regulator circuitry 120. The output of the multi-phase voltage regulator circuitry 130 is structured to be coupled to a load, such as the programmable circuitry 140 of FIG. 1. The multi-phase voltage regulator circuitry 130 produces a supply voltage (VCC) by stepping down a supply voltage (VDD) from the DC power supply. The multi-phase voltage regulator circuitry 130 provides the supply voltage (VCC) to the load.

The power stage 205 has a first input, a second input, a first output, and a second output. The first input of the power stage 205 is coupled to the input of the multi-phase voltage regulator circuitry 130, which provides the supply voltage (VDD). The second input of the power stage 205 is coupled to the controller 240, which provides a first PWM signal (PWM_1). The first output of the power stage 205 is coupled to the inductor 220. The second output of the power stage 205 is coupled to the controller 240, which receives a first current sense signal (CS_1).

The power stage 210 has a first input, a second input, a first output, and a second output. The first input of the power stage 210 is coupled to the input of the multi-phase voltage regulator circuitry 130, which provides the supply voltage (VDD). The second input of the power stage 210 is coupled to the controller 240, which provides a second PWM signal (PWM_2). The first output of the power stage 210 is coupled to the inductor 225. The second output of the power stage 210 is coupled to the controller 240, which receives a second current sense signal (CS_2).

The power stage 215 has a first input, a second input, a first output, and a second output. The first input of the power stage 215 is coupled to the input of the multi-phase voltage regulator circuitry 130, which provides the supply voltage (VDD). The second input of the power stage 215 is coupled to the controller 240, which provides a third PWM signal (PWM_N). The first output of the power stage 215 is coupled to the inductor 230. The second output of the power stage 215 is coupled to the controller 240, which receives a third current sense signal (CS_N).

The inductor 220 has a first terminal and a second terminal. The first terminal of the inductor 220 is coupled to the power stage 205. The second terminal of the inductor 220 is coupled to the inductors 225, 230, the capacitor 235, and the output of the multi-phase voltage regulator circuitry 130, which provides the supply voltage (VCC).

The inductor 225 has a first terminal and a second terminal. The first terminal of the inductor 225 is coupled to the power stage 210. The second terminal of the inductor 225 is coupled to the inductors 220, 230, the capacitor 235, and the output of the multi-phase voltage regulator circuitry 130, which provides the supply voltage (VCC).

The inductor 230 has a first terminal and a second terminal. The first terminal of the inductor 230 is coupled to the power stage 215. The second terminal of the inductor 230 is coupled to the inductors 220, 225, the capacitor 235, and the output of the multi-phase voltage regulator circuitry 130, which provides the supply voltage (VCC).

The capacitor 235 has a first terminal and a second terminal. The first terminal of the capacitor 235 is coupled to the inductors 220, 225, 230 and the output of the multi-phase voltage regulator circuitry 130, which provides the supply voltage (VCC). The second terminal of the capacitor 235 is coupled to a common terminal, which provides a common potential (e.g., ground, AVSS, etc.). In some examples, the inductors 220, 225, 230 and the capacitor 235 may be illustrated or described as filter circuitry. In such examples, the inductors 220, 225, 230 and the capacitor 235 form a low pass LC filter.

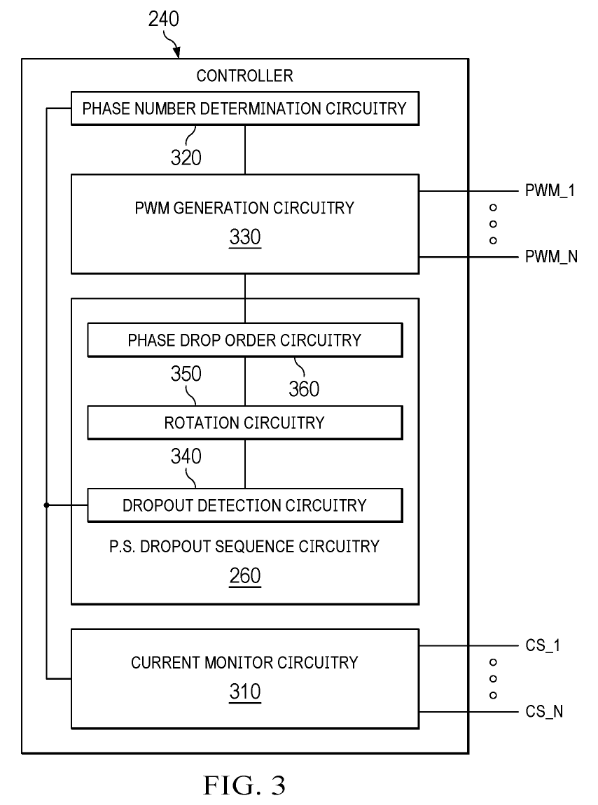

The controller 240 has a first input, a second input, a third input, a first output, a second output, and a third output. The first input of the controller 240 is coupled to the power stage 205. The second input of the controller 240 is coupled to the power stage 210. The third input of the controller 240 is coupled to the power stage 215. The first output of the controller 240 is coupled to the power stage 205. The second output of the controller 240 is coupled to the power stage 210. The third output of the controller 240 is coupled to the power stage 215. An example of the controller 240 is further illustrated and described in connection with FIG. 3.

The transistor 245 has a first terminal, a second terminal, and a control terminal. The first terminal of the transistor 245 is coupled to the input of the multi-phase voltage regulator circuitry 130, which provides the supply voltage (VDD). The second terminal of the transistor 245 is coupled to the inductor 220, the transistor 250, and the current sensor 255. The control terminal of the transistor 245 is coupled to the controller 240, which provides the first PWM signal (PWM_1).

The transistor 250 has a first terminal, a second terminal, and a control terminal. The first terminal of the transistor 250 is coupled to the inductor 220, the transistor 245, and the current sensor 255. The second terminal of the transistor 250 is coupled to the common terminal, which provides the common potential. The control terminal of the transistor 250 is coupled to the controller 240, which provides the first PWM signal (PWM_1).

In the example of FIG. 2, the transistors 245, 250 are n-channel metal-oxide semiconductor field-effect transistors (MOSFETs). Alternatively, the transistors 245, 250 may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. The transistors 245, 250 may be depletion mode devices, drain-extended devices, enhancement mode devices, natural transistors or other type of device structure transistors. Furthermore, the transistors 245, 250 may be implemented in/over a silicon substrate (Si), a silicon carbide substrate (SiC), a gallium nitride substrate (GaN) or a gallium arsenide substrate (GaAs).

The current sensor 255 has an input and an output. The input of the current sensor 255 is coupled to the inductor 220 and the transistors 245, 250. The output of the current sensor 255 is coupled to the controller 240. In some examples, the current sensor 255 is an inline current sensor, which uses a relatively small sense resistance to measure current. In other examples, the current sensor 255 is a replica of the power stage 205, which uses scaled transistors to replicate the current through the transistors 245, 250. The current sensor 255 provides the first current sense signal (CS_1) to the controller 240 to represent the current at the output.

In example operations, the power stages 205, 210, 215 receive the supply voltage (VDD) and the PWM signals (PWM_1, PWM_2, PWM_N). In the example of FIG. 2, the PWM signals (PWM_1, PWM_2, PWM_N) are tri-state signals. For example, the controller 240 can set the state of the first PWM signal (PWM_1) to one of a low, mid, or high state. In the high state, the transistor 245 conducts current to couple the inductor 220 to the supply terminal, which provides the supply voltage (VDD). In the low state, the transistor 250 conducts current to form a current path from the inductor 220 to the common terminal, which provides the common potential. In the mid-state, neither of the transistors 245, 250 conduct current. In some examples, the controller 240 sets the PWM signal (PWM_1) to the mid-state to drop the power stage 205.

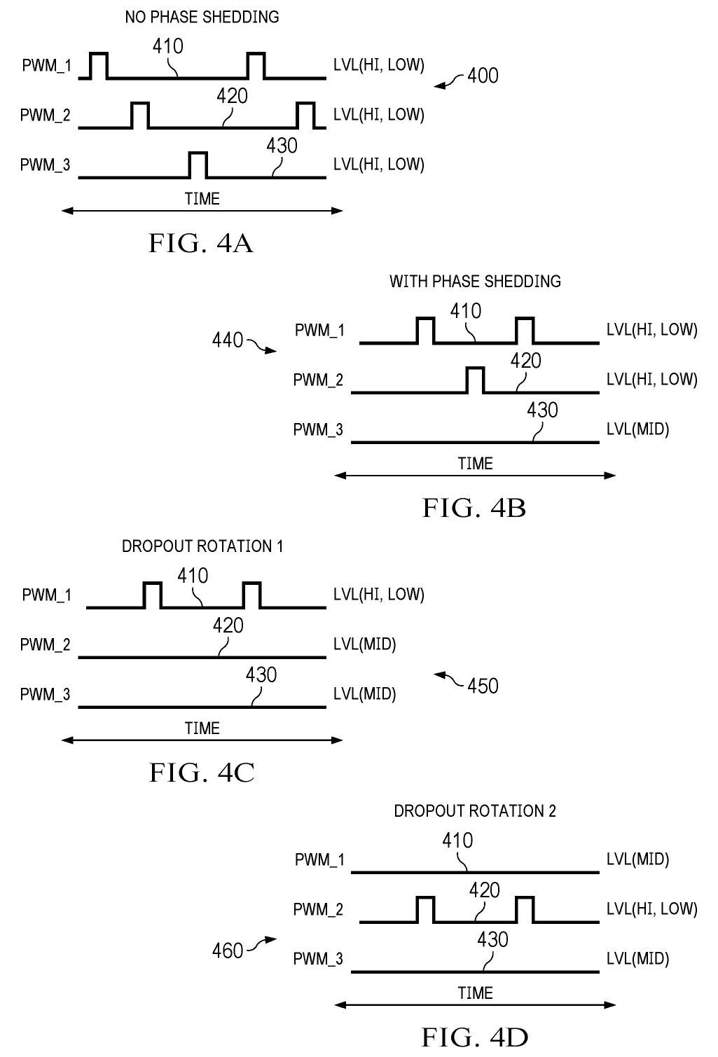

In such example operations, the controller 240 generates the PWM signals (PWM_1, PWM_2, PWM_N) having pulses that are phase shifted in reference to one another. For example, the controller 240 phase shifts a pulse of the second PWM signal (PWM_2) by one-hundred and twenty degrees and a pulse of the third PWM signal (PWM_N) by two-hundred and forty degrees. In such examples, the controller 240 divides three-hundred and sixty degrees by the number of PWM signals to determine the different phases of the PWM signals (PWM_1, PWM_2, PWM_N). In the example of FIG. 2, the PWM signals (PWM_1, PWM_2, PWM_N) control one of the power stages 205, 210, 215. Examples of the PWM signals (PWM_1, PWM_2, PWM_N) are further illustrated and described in connection with FIGS. 4A, 4B, 4C, and 4D.

In example operations, the inductors 220, 225, 230 regulate the supply of current to the capacitor 235 and the output of the multi-phase voltage regulator circuitry 130. The capacitor 235 sets the output of the multi-phase voltage regulator circuitry 130 to the supply voltage (VCC) responsive to the current from the inductors 220, 225, 230. The inductors 220, 225, 230 and the capacitor 235 step down the supply voltage (VDD) to boost the current at the output of the multi-phase voltage regulator circuitry 130. In some examples, the inductors 220, 225, 230 and the capacitor 235 form a low pass filter. The LC filter circuitry of the inductors 220, 225, 230 and the capacitor 235 filters relatively high-speed changes in the current from the power stage 205, 210, 215 to provide a relatively high current at a relatively low supply voltage (VCC) to a load. In some examples, the capacitor 235 decouples the load from the switching operations of the multi-phase voltage regulator circuitry 130. In other examples, the multi-phase voltage regulator circuitry 130 includes another capacitor to decouple the load from the power stages 205, 210, 215.

In example operations, the controller 240 monitors a power consumption by the load using the current sense signals (CS_1, CS_2, CS_N). The controller 240 begins phase shedding operations responsive to a decrease in the power consumption by the load. For example, if the power stages 205, 210, 215 are providing power and the controller 240 determines the power consumption can be satisfied by two of the power stages 205, 210, 215, the controller 240 begins phase shedding operations.

In example phase shedding operations, the controller 240 decreases the current at the output of the multi-phase voltage regulator circuitry 130 by disabling one or more of the PWM signals (PWM_1, PWM_2, PWM_N). For example, if the current sense signals (CS_1, CS_2, CS_N) indicate a decrease in current consumed by the programmable circuitry 140, the controller 240 begins phase shedding the PWM signals (PWM_1, PWM_2, PWM_N). In such examples, the controller 240 drops (e.g., sets to a fixed state) one or more of the PWM signals (PWM_1, PWM_2, PWM_N) using a dropout order from the PS dropout circuitry 260. The dropout order of the PS dropout circuitry 260 is an order in which the controller 240 is to drop the PWM signals (e.g., set to the mid-state).

In such example phase shedding operations, the PS dropout circuitry 260 provides the dropout order to control the order in which the PWM signals are dropped. The PS dropout circuitry 260 also monitors conditions of the multi-phase voltage regulator circuitry 130 to detect a rotation event. In some examples, the PS dropout circuitry 260 generates a rotation event responsive to certain conditions of the multi-phase voltage regulator circuitry 130. For example, rotation events occur periodically, such as after a duration of time. In another example, a rotation event occurs after the number of active PWM signals decreases to one. In such examples, the PS dropout circuitry 260 can wait to generate a rotation event until after the condition is met a plurality of times. In both examples, the PS dropout circuitry 260 rotates the dropout order of the PWM signals (PWM_1, PWM_2, PWM_N) responsive to a rotation event.

Advantageously, rotating the dropout order of the PWM signals (PWM_1, PWM_2, PWM_N) distributes stress from component aging across the power stages 205, 210, 215. Advantageously, distributing stress across the power stages 205, 210, 215 reduces component mismatch over time, improves reliability, and extends a produce lifetime. Example operations of the PS dropout circuitry 260 or, more generally, the controller 240 are further illustrated and described in connection with FIGS. 3, 5, 9, and 13.

FIG. 3 is a block diagram of an example implementation of the controller 240 of FIG. 2. The controller 240 of FIG. 3 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the controller 240 of FIG. 3 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers. In the example of FIG. 3, the controller 240 includes the PS dropout circuitry 260, example current monitor circuitry 310, example phase number determination circuitry 320, and example PWM generation circuitry 330. The example PS dropout circuitry 260 of FIG. 3 includes example dropout detection circuitry 340, example rotation circuitry 350, and example phase drop order circuitry 360.

The controller 240 has inputs and outputs. The inputs of the controller 240 are structured to be coupled to the power stages 205, 210, 215, which provide the current sense signals (CS_1, CS_2, CS_N). The outputs of the controller 240 are structured to be coupled to the power stages 205, 210, 215. The controller 240 uses the current sense signals (CS_1, CS_2, CS_N) to determine a number of phases are needed to supply power. The controller 240 uses a dropout order from the PS dropout circuitry 260 to determine which of the PWM signals (PWM_1, PWM_2, PWM_N) to generate the determined number of phases. The controller 240 provides the PWM signals (e.g., PWM_1, PWM_2, PWM_N) to the power stages 205, 210, 215.

The PS dropout circuitry 260 has an input and an output. The input of the PS dropout circuitry 260 is coupled to the current monitor circuitry 310, which provides a power consumption value of a load (e.g., the programmable circuitry 140). The output of the PS dropout circuitry 260 is coupled to the PWM generator circuitry 330. The PS dropout circuitry 260 provides a dropout order of the PWM signals (e.g., PWM_1, PWM_2, PWM_N). The PS dropout circuitry 260 rotates the dropout order of the PWM signals (e.g., PWM_1, PWM_2, PWM_N) responsive to a rotation event. In the example of FIG. 3, the PS dropout circuitry 260 generates rotation events using the power consumption value from the current monitor circuitry 310. In some examples, the PS dropout circuitry 260 is instantiated by ASIC or programmable circuitry executing phase shedding dropout instructions to perform operations such as those represented by the flowcharts of FIGS. 5, 9, and 13.

The current monitor circuitry 310 has inputs and an output. The inputs of the current monitor circuitry 310 are structured to be coupled to the power stages 205, 210, 215, which provide the current sense signals (CS_1, CS_2, CS_N). The output of the current monitor circuitry 310 is coupled to the PS dropout circuitry 260 and the phase number determination circuitry 320. The current monitor circuitry 310 determines the current supplied by the power stages 205, 210, 215 using the current sense signals (CS_1, CS_2, CS_N). The current monitor circuitry 310 combines the supplied currents to determine power consumption by a load. For example, the current monitor circuitry 310 sums the current through each of the power stages 205, 210, 215 to determine a power consumption value. The power consumption value represents the power consumption by a load (e.g., the programmable circuitry 140). The current monitor circuitry 310 provides the power consumption value to the PS dropout circuitry 260 and the phase number determination circuitry 320. In some examples, the current monitor circuitry 310 is instantiated by ASIC or programmable circuitry executing current monitor instructions to perform operations such as those represented by the flowcharts of FIGS. 5, 9, and 13.

The phase number determination circuitry 320 has an input and an output. The input of the phase number determination circuitry 320 is coupled to the current monitor circuitry 310, which provides the power consumption value. The output of the phase number determination circuitry 320 is coupled to the PWM generation circuitry 330. The phase number determination circuitry 320 determines a number of PWM signals needed to produce the power consumption value. For example, the phase number determination circuitry 320 compares the power consumption value to multiple thresholds. In such examples, the thresholds correspond to the different number of PWM signals at the output of the controller 240. The phase number determination circuitry 320 provides the determined number of PWM signals to the PWM generation circuitry 330. In some examples, the phase number determination circuitry 320 is instantiated by ASIC or programmable circuitry executing phase number determination instructions to perform operations such as those represented by the flowcharts of FIGS. 5, 9, and 13.

The PWM generation circuitry 330 has a first input, a second input, and outputs. The first input of the PWM generation circuitry 330 is coupled to the PS dropout circuitry 260, which provides the dropout order. The second input of the PWM generation circuitry 330 is coupled to the phase number determination circuitry 320, which provides the number of PWM signals to generate. The PWM generation circuitry 330 generates the determined number of phases of the PWM signals (PWM_1, PWM_2, PWM_N) using the dropout order. Examples of the PWM signals (PWM_1, PWM_2, PWM_N) are further illustrated and described in connection with FIGS. 4A, 4B, and 4C. In some examples, the PWM generation circuitry 330 is instantiated by ASIC or programmable circuitry executing PWM generation instructions to perform operations such as those represented by the flowcharts of FIGS. 5, 9, and 13.

The dropout detection circuitry 340 has an input and an output. The input of the dropout detection circuitry 340 is coupled to the current monitor circuitry 310, which provides the power consumption value. The output of the dropout detection circuitry 340 is coupled to the rotation circuitry 350. The dropout detection circuitry 340 compares the power consumption value to a dropout threshold to sense dropout conditions. In some examples, the dropout threshold corresponds to power consumption values equal to or less than the power provided by a single one of the power stages 205, 210, 215. In such examples, the dropout detection circuitry 340 generates an indication when a single power stage is driving the output of the multi-phase voltage regulator circuitry 130. In other examples, the dropout detection circuitry 340 uses the power consumption value to monitor for an alternative condition or state. In some examples, the dropout detection circuitry 340 is instantiated by ASIC or programmable circuitry executing dropout detection instructions to perform operations such as those represented by the flowcharts of FIGS. 5, 9, and 13.

The rotation circuitry 350 has an input and an output. The input of the rotation circuitry 350 is coupled to the dropout detection circuitry 340, which provides the dropout detection indication. The output of the rotation circuitry 350 is coupled to the phase drop order circuitry 360. The rotation circuitry 350 rotates dropout order of the phase drop order circuitry 360 responsive to a rotation event. In some examples, a rotation event corresponds to the output of the dropout detection circuitry 340. In other examples, the rotation circuitry 350 generates a rotation event after receiving the dropout detection indication a plurality of times. In such examples, the rotation circuitry 350 rotates the dropout order of the phase drop order circuitry 360 after a threshold count of dropout detection indications is greater than or equal to a threshold value. In some examples, the rotation circuitry 350 is instantiated by ASIC or programmable circuitry executing rotation instructions to perform operations such as those represented by the flowcharts of FIGS. 5, 9, and 13.

The phase drop order circuitry 360 has an input and an output. The input of the phase drop order circuitry 360 is coupled to the rotation circuitry 350. The output of the phase drop order circuitry 360 is coupled to the PWM generation circuitry 330. The phase drop order circuitry 360 stores the dropout order of the PWM signals (PWM_1, PWM_2, PWM_N). In some examples, such as in FIGS. 6, 10, and 14, the phase drop order circuitry 360 uses a first-in first-out (FIFO) queue to store the dropout order. In the example of FIG. 3, the dropout order is a queue of the PWM signals (PWM_1, PWM_2, PWM_N) representing an order at which the PWM generation circuitry 330 is to drop the PWM signals. In some examples, the phase drop order circuitry 360 is instantiated by ASIC or programmable circuitry executing phase drop order instructions to perform operations such as those represented by the flowcharts of FIGS. 5, 9, and 13.

FIG. 4A is a plot 400 of example operations of the controller 240 of FIGS. 2 and 3. In the example of FIG. 4A, the plot 400 illustrates a first PWM signal 410 (PWM_1), a second PWM signal 420 (PWM_2), and a third PWM signal 430 (PWM_N). The PWM signal 410 represents a signal from the PWM generation circuitry 330 to control the power stage 205. The PWM signal 420 represents a signal from the PWM generation circuitry 330 to control the power stage 210. The PWM signal 430 represents a signal from the PWM generation circuitry 330 to control the power stage 215.

In example operations, if the phase number determination circuitry 320 determines the need for power from three power stages, the controller 240 generates the PWM signals 410, 420, 430 of FIG. 4A. For example, if the current monitor circuitry 310 determines the programmable circuitry 140 is consuming power from all three of the power stages 205, 210, 215. In such example operations, the phases of pulses of the PWM signals 410, 420, 430 are set to divide three-hundred and eighty degrees of total phase shift. In the example of FIG. 4A, the phase shift between rising edges of the PWM signals 410, 420, 430 is approximately one-hundred and twenty degrees. Advantageously, the plot 400 illustrates example operations of the controller 240 without phase shedding.

FIG. 4B is a plot 440 of example operations of the controller 240 of FIGS. 2 and 3. In the example of FIG. 4B, the plot 440 illustrates the PWM signals 410, 420, 430 (PWM_1, PWM_2, PWM_N). The PWM signals 410, 420, 430 represent signals from the PWM generation circuitry 330 to control the power stages 205, 210, 215. However, unlike the example of FIG. 4A, the plot 440 illustrates phase shedding operations of the controller 240.

In example operations, if the phase number determination circuitry 320 determines the need for power from only two of the three power stages, the controller 240 generates the PWM signals 410, 420 of FIG. 4B and drops the PWM signal 430 of FIG. 4B. For example, if the current monitor circuitry 310 determines the programmable circuitry 140 is consuming power that can be supplied by only two of the power stages 205, 210, 215. In such example operations, the phases of pulses of the PWM signals 410, 420 are set to divide three-hundred and eighty degrees of total phase shift. In the example of FIG. 4B, the phase shift between rising edges of the PWM signals 410, 420 is approximately one-hundred and eighty degrees. Advantageously, the plot 440 illustrates example operations of the controller 240 with phase shedding beginning.

FIG. 4C is a plot 450 of example operations of the controller 240 of FIGS. 2 and 3. In the example of FIG. 4C, the plot 450 illustrates the PWM signals 410, 420, 430 (PWM_1, PWM_2, PWM_3). The PWM signals 410, 420, 430 represent signals from the PWM generation circuitry 330 to control the power stages 205, 210, 215. However, unlike the example of FIGS. 4A and 4B, the plot 450 illustrates phase shedding operations of the controller 240.

In example operations, if the phase number determination circuitry 320 determines the need for power from one or less of the power stages 205, 210, 215, the controller 240 generates the PWM signal 410 of FIG. 4C and drops the PWM signals 420, 430 of FIG. 4C. For example, if the current monitor circuitry 310 determines the programmable circuitry 140 is consuming power that can be supplied by one of the power stages 205, 210, 215. Advantageously, the plot 450 illustrates example operations of the controller 240 for a maximum phase shedding.

FIG. 4D is a plot 460 of example operations of the controller 240 of FIGS. 2 and 3. In the example of FIG. 4D, the plot 460 illustrates the PWM signals 410, 420, 430 (PWM_1, PWM_2, PWM_3). The PWM signals 410, 420, 430 represent signals from the PWM generation circuitry 330 to control the power stages 205, 210, 215. However, unlike the example of FIGS. 4A, 4B, and 4C, the plot 460 illustrates phase shedding operations of the controller 240 after a rotation event.

In example operations, if the phase number determination circuitry 320 determines the need for power from one or less of the power stages 205, 210, 215, the controller 240 generates the PWM signal 420 of FIG. 4D and drops the PWM signals 410, 430 of FIG. 4D. For example, if the current monitor circuitry 310 determines the programmable circuitry 140 is consuming power that can be maintained by one of the power stages 205, 210, 215 and a rotation event has occurred. Advantageously, the plot 460 illustrates example operations of the controller 240 for a maximum phase shedding after a rotation event. Advantageously, during the phase shedding of FIG. 4D, the rotation event between the plots 450, 460 changes the power stage that remains active from the power stage 205 to the power stage 210. Advantageously, such a change reduces the difference in age between the power stages 205, 210. Additional rotation events are further illustrated and described in connection with FIG. 6.

FIG. 5 is a flowchart representative of example machine-readable instructions or example operations 500 that may be at least one of executed, instantiated, or performed using an example implementation of the controller 240 of FIGS. 2 and 3 or, more generally, the multi-phase voltage regulator circuitry 130 of FIGS. 1 and 2. The example operations 500 begin at Block 505 at which the phase drop order circuitry 360 sets an initial PWM dropout order. In example operations, the phase drop order circuitry 360 initializes the dropout order of the PWM signals (PWM_1, PWM_2, PWM_N) in ascending order. For example, the phase drop order circuitry 360 generates a FIFO queue to represent the dropout order. In such examples, the phase drop order circuitry 360 sets the initial dropout order responsive to populating the FIFO queue with indications of each of the PWM signals (PWM_1, PWM_2, PWM_N). An example of the initial dropout order is further illustrated and described in connection with FIG. 6.

The PWM generation circuitry 330 generates PWM signal(s) to turn on power stages. (Block 510). In example operations, the PWM generation circuitry 330 generates the PWM signals 410, 420, 430 (PWM_1, PWM_2, PWM_N) to control the power stages 205, 210, 215. In such example operations, the power stages 205, 210, 215 generate the supply voltage (VCC) at the output of the multi-phase voltage regulator circuitry 130 responsive to the PWM signals 410, 420, 430 (PWM_1, PWM_2, PWM_N).

The current monitor circuitry 310 determines power being consumed. (Block 515). In example operations, the current monitor circuitry 310 determines the current supplied by the power stages 205, 210, 215 using the current sense signals (CS_1, CS_2, CS_N). In such examples, the current sense signals (CS_1, CS_2, CS_N) represent the current consumed by a load coupled to the output of the multi-phase voltage regulator circuitry 130, such as the programmable circuitry 140.

The phase number determination circuitry 320 determines if a PWM signal can be turned off. (Block 520). In example operations, the phase number determination circuitry 320 compares the power consumption from the current monitor circuitry 310 to multiple threshold values. In some examples, the phase number determination circuitry 320 determines a number of the PWM signals 410, 420, 430 that are needed to supply the power being consumed responsive to the comparison. In such example operations, the phase number determination circuitry 320 determines a PWM signal can be turned off responsive to a decrease in power consumption. The phase number determination circuitry 320 provides the determined number of PWM signals to the PWM generation circuitry 330.

If the phase number determination circuitry 320 determines that a PWM signal can be turned off (e.g., Block 520 returns a result of YES), the PWM generation circuitry 330 determines if more than one PWM signal is being generated. (Block 525). In example operations, the PWM generation circuitry 330 determines the number of the PWM signals 410, 420, 430 to generate responsive to the phase number determination circuitry 320. In some examples, such as when the programmable circuitry 140 is in an idle condition, the phase number determination circuitry 320 determines that none of the PWM signals are needed. In such examples, the PWM generation circuitry 330 ensures that the multi-phase voltage regulator circuitry 130 is supplying at least a minimum amount of power to a load at any given time.

If the PWM generation circuitry 330 determines that more than one PWM signal is being generated (e.g., Block 525 returns a result of YES), the PWM generation circuitry 330 drops the next PWM signal in the dropout order. (Block 530). In example operations, the PWM generation circuitry 330 drops at least one of the PWM signals 410, 420, 430 responsive to the determination that more than one of the PWM signals 410, 420, 430 are active. For example, the PWM generation circuitry 330 sets the PWM signal 430 to a mid-state to drop the power stage 215. Such an example is further illustrated and described in connection with FIG. 4B. In such example operations, the PWM generator circuitry 330 uses the dropout order from the phase drop order circuitry 360 to determine which of the PWM signals 410, 420, 430 to drop. For example, if the PWM signal 430 is already dropped, the PWM generation circuitry 330 drops one of the PWM signals 410, 420 based on the current dropout order. Examples of the dropout order are further illustrated and described in connection with FIGS. 6, 10, and 13.

If the PWM generation circuitry 330 determines that a PWM signal cannot be turned off (e.g., Block 520 returns a result of NO), the PWM generation circuitry 330 determines that only a single PWM signal is being generated (e.g., Block 525 returns a result of NO), or control proceeds from Block 530, the rotation circuitry 350 determines if a rotation event has occurred. (Block 535). In example operations, the dropout detection circuitry 340 monitors the power consumption value. In some examples, the dropout detection circuitry 340 compares the power consumption to a threshold power consumption. In such examples, the dropout detection circuitry 340 the comparison may correspond to a number of power stages providing power to a load. For example, the dropout detection circuitry 340 generates a dropout indication responsive to a determination that the load is consuming power less than a minimum power. In such example operations, the rotation circuitry 350 determines if a rotation event occurs using the indication from the dropout detection circuitry 340. In some examples, the rotation circuitry 350 generates a rotation event for every indication from the dropout detection circuitry 340. In other examples, the rotation circuitry 350 waits to generate a rotation event until the dropout detection circuitry 340 provides a plurality of indications. For example, the dropout condition occurs multiple times between rotation events. Advantageously, the rotation circuitry 350 generates a rotation event responsive to power consumption by a load coupled to the output of the multi-phase voltage regulator circuitry 130.

If the rotation circuitry 350 determines that a rotation event has occurred (e.g., Block 535 produces a result of YES), the rotation circuitry 350 rotates the dropout order of the power stages. (Block 540). In example operations, the rotation circuitry 350 changes the dropout order of the phase drop order circuitry 360 responsive to a rotation event. In some examples, if the phase drop order circuitry 360 operates as a FIFO queue, the rotation circuitry 350 rotates the dropout order by moving the PWM signal at the start of the FIFO queue to the end of the queue. Example rotations of the dropout order are further illustrated and described in connection with FIGS. 6, 10, and 14.

If the rotation circuitry 350 determines that a rotation event has not occurred (e.g., Block 535 produces a result of NO) or control proceeds from Block 540), the phase number determination circuitry 320 determines if an additional PWM signal is needed. (Block 545). In example operations, the phase number determination circuitry 320 compares the power consumption from the current monitor circuitry 310 to the threshold values. In some examples, the phase number determination circuitry 320 determines the number of the PWM signals 410, 420, 430 needed to supply the power being consumed responsive to the comparison. In such example operations, the phase number determination circuitry 320 determines a PWM signal can be turned on responsive to an increase in power consumption. The phase number determination circuitry 320 provides the determined number of PWM signals to the PWM generation circuitry 330. If the phase number determination circuitry 320 determines that an additional PWM signal is not needed (e.g., Block 545 returns a result of NO), control proceeds to return to Block 515.

If the phase number determination circuitry 320 determines that an additional PWM signal is needed (e.g., Block 545 returns a result of YES), the PWM generation circuitry 330 generates an additional PWM signal using the dropout order. (Block 550). In example operations, the PWM generation circuitry 330 add another (e.g., enables, turns on, allows to be set, etc.) one of the PWM signals 410, 420, 430 responsive to the determination that the power consumption is increasing. Control proceeds to return to Block 515.

Example methods are described with reference to the flowchart illustrated in FIG. 5. However, many other methods of implementing the controller 240 of FIGS. 2 and 3 or, more generally, the multi-phase voltage regulator circuitry 130 of FIGS. 1 and 2 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 6 is a timing diagram 600 of an example rotation of a dropout order 610 of the power stages 205, 210, 215 of FIG. 2 across multiple rotation events. In the example of FIG. 6, the timing diagram 600 illustrates the dropout order 610 after a plurality of rotation events. The example dropout order 610 of FIG. 6 illustrates an example dropout order if the multi-phase voltage regulator circuitry 130 includes twelve power stages (e.g., the power stages 205, 210, 215). Also, in example operations, the controller 240 produces a PWM signal for each of the twelve power stages (PWR_STG1-PWR_STG12). For example, the controller 240 produces PWM signals (PWM_1-PWM_12) to individually control the twelve power stages (PWR_STG1-PWR_STG12).

At a first time 620 (DO_1), which is before a first rotation event, the dropout order 610 is an initial dropout order. During phase shedding operations after the time 620, the PWM generation circuitry 330 first drops the PWM signal (PWM_12) which controls a twelfth power stage (PWR_STG12). In such examples, the PWM generation circuitry 330 drops the power stages (PWR_STG12-PWR_STG2) in descending order. However, after the time 620, the PWM generation circuitry 330 continues to generate the PWM signal (PWM_1), which drives the power stage 205 (PWR_STG1), to supply a minimum amount of power. In such example operations, the controller 240 keeps the power stage 205 (PWR_STG1) active to supply the minimum amount of power to a load.

Between the time 620 and a second time 630, the controller 240 determines conditions for a rotation event have been met. In example operations, the rotation circuitry 350 rotates the dropout order 610 responsive to detecting the rotation event prior to the time 630. In the example of FIG. 6, the rotation circuitry 350 rotates the dropout order 610 as a FIFO queue. Alternatively, another method of rotating the order may be implemented using this description. At the time 630, the PWM generation circuitry 330 first drops the PWM signal (PWM_1) which controls the power stage 205 (PWR_STG1). In such examples, the PWM generation circuitry 330 drops the power stages (PWM_STG1, PWR_STG12-PWR_STG3) in descending order. However, after the time 630, the PWM generation circuitry 330 continues to generate the PWM signal (PWM_2), which drives the power stage 210 (PWR_STG2), to supply a minimum amount of power. In such example operations, the controller 240 keeps the power stage 210 (PWR_STG2) active to supply the minimum amount of power to a load.

Between the time 630 and a third time 640, the controller 240 determines conditions for multiple rotation events have been met. Between the times 630, 640, the rotation circuitry 350 rotates the dropout order 610 ten additional times responsive to ten subsequent rotation events. At the time 640, the dropout order 610 illustrates the order that is eleven rotation events after the initial dropout order at the time 620. During phase shedding operations after the time 640, the PWM generation circuitry 330 first drops the PWM signal (PWM_11) which controls an eleventh power stage (PWR_STG11). In such examples, the PWM generation circuitry 330 drops the power stages (PWR_STG11-PWR_STG1) in descending order. However, after the time 640, the PWM generation circuitry 330 continues to generate the PWM signal (PWM_12), which drives the twelfth power stage (PWR_STG12), to supply a minimum amount of power. In such example operations, the controller 240 keeps the power stage (PWR_STG12) active to supply the minimum amount of power to a load.

Between the time 640 and a fourth time 650, the controller 240 determines conditions for a rotation event have been met. In example operations, the rotation circuitry 350 rotates the dropout order 610 responsive to detecting the rotation event prior to the time 650. Between the times 620, 650, the rotation circuitry 350 rotates the dropout order 610 twelve times responsive to twelve rotation events. At the time 650, the dropout order 610 returns to the initial dropout order at the time 620. After the time 650, the PS dropout circuitry 260 continues to rotate the dropout order 610.

Advantageously, the controller 240 rotates which of one the power stages (PWR_STG1-PWR_STG12) is kept active during phase shedding. Advantageously, rotating the dropout order 610 spreads out the aging of component use across all of the power stages (PWR_STG1-PWR_STG12). Advantageously, spreading out the aging of components across the power stages (PWR_STG1-PWR_STG12) reduces mismatch, which increases performance.

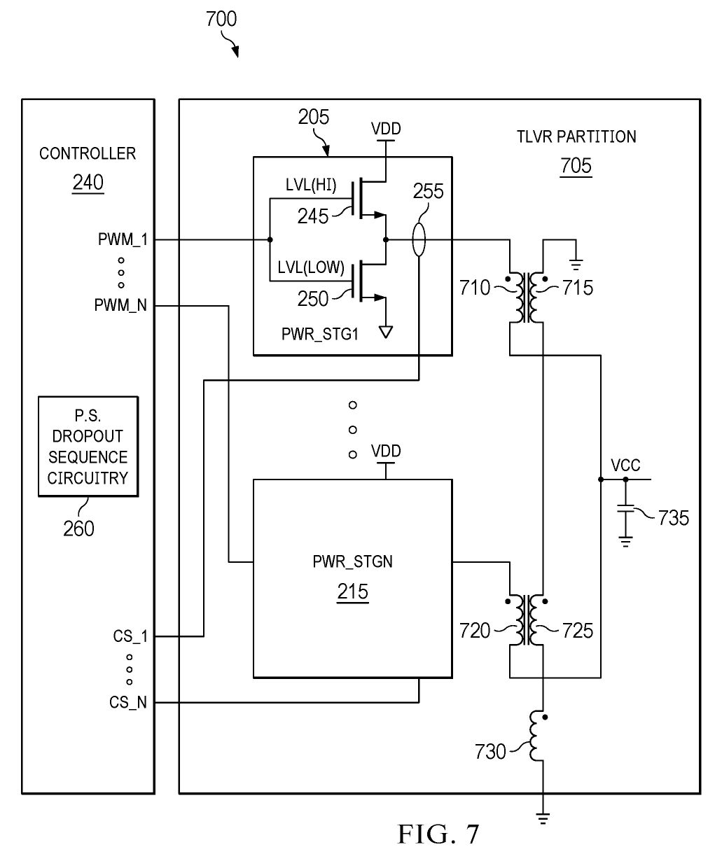

FIG. 7 is a schematic diagram of example multi-phase voltage regulator circuitry 700, which is another example of the multi-phase voltage regulator circuitry 130 of FIGS. 1 and 2. Unlike in the example of FIG. 2, the multi-phase voltage regulator circuitry 700 uses an example trans-inductor voltage regulator (TLVR) partition 705 to produce the supply voltage (VCC) at the output of the multi-phase voltage regulator circuitry 700. The example TLVR partition 705 of FIG. 7 includes the power stages 205, 215, a first inductor 710, a second inductor 715, a third inductor 720, a fourth inductor 725, a fifth inductor 730, and a capacitor 735. Alternatively, the TLVR partition 705 may include any number of power stages that are coupled to any number of magnetically coupled inductors.

The multi-phase voltage regulator circuitry 700 has an input and an output. The input of the multi-phase voltage regulator circuitry 700 is structured to be coupled to a DC power supply, such as the DC-DC regulator circuitry 120. The output of the multi-phase voltage regulator circuitry 700 is structured to be coupled to a load, such as the programmable circuitry 140 of FIG. 1. The multi-phase voltage regulator circuitry 700 produces a supply voltage (VCC) by stepping down a supply voltage (VDD) from the DC power supply. The multi-phase voltage regulator circuitry 700 is structured to provide the supply voltage (VCC) to the load, such as the programmable circuitry 140.

The TLVR partition 705 has a first input, second inputs, a first output, and second outputs. The first input of the TLVR partition 705 is coupled to the input of the multi-phase voltage regulator circuitry 700, which provides the supply voltage (VDD). The second inputs of the TLVR partition 705 are coupled to the controller 240, which provides the PWM signals (PWM_1, PWM_N). The first output of the TLVR partition 705 is coupled to the output of the multi-phase voltage regulator circuitry 700. The second outputs of the TLVR partition 705 are coupled to the controller 240.

The inductor 710 has a first terminal and a second terminal. The first terminal of the inductor 710 is coupled to the power stage 205. The second terminal of the inductor 710 is coupled to the inductor 720, the capacitor 735, and the output of the multi-phase voltage regulator circuitry 700, which supplies the supply voltage (VCC). The inductor 715 has a first terminal and a second terminal. The first terminal of the inductor 715 is coupled to the inductor 725. The second terminal of the inductor 715 is coupled to the common terminal, which provides the common potential. The inductors 710, 715 are magnetically coupled. In some examples, the inductors 710, 715 share a common core.

The inductor 720 has a first terminal and a second terminal. The first terminal of the inductor 720 is coupled to the power stage 215. The second terminal of the inductor 720 is coupled to the inductor 710, the capacitor 735, and the output of the multi-phase voltage regulator circuitry 700, which supplies the supply voltage (VCC). The inductor 725 has a first terminal and a second terminal. The first terminal of the inductor 725 is coupled to the inductor 715. The second terminal of the inductor 725 is coupled to the inductor 730. The inductors 720, 725 are magnetically coupled. In some examples, the inductors 720, 725 share a common core.

In the example of FIG. 7, the inductors 710, 720 are indirectly coupled by the inductors 715, 725. In such examples, indirectly coupling the inductors 710, 720 using the inductors 715, 725 symmetrically couples the phases of the power stages 205, 215 without sharing a core. Advantageously, indirectly coupling the inductors 710, 720 using the inductors 715, 725 reduces the complexity of a core coupling the inductors 710, 715 and the inductors 720, 725.

The inductor 730 has a first terminal and a second terminal. The first terminal of the inductor 730 is coupled to the inductor 725. The second terminal of the inductor 730 is coupled to the common terminal, which provides the common potential. In some examples, the inductors 710, 720 are indirectly coupled by the current path through the inductors 715, 725, 730. In some examples, the inductor 730 is referred to as a compensation inductor, which controls a coupling coefficient of the TLVR partition 705. Alternatively, the TLVR partition 705 may be modified to exclude the inductor 730.

The capacitor 735 has a first terminal and a second terminal. The first terminal of the capacitor 735 is coupled to the inductors 710, 720 and the output of the multi-phase voltage regulator circuitry 700, which supplies the supply voltage (VCC). The second terminal of the capacitor 735 is coupled to the common terminal, which provides the common potential.

In example operations, similar to the multi-phase voltage regulator circuitry 130 of FIG. 2, the power stages 205, 215 regulate the supply of power from the supply voltage (VDD) responsive to the PWM signals (PWM_1, PWM_N) from the controller 240. In the example of FIG. 2, the inductors 220, 225, 230 and the capacitor 235 from low pass filter to regulate the output of the multi-phase voltage regulator circuitry 130. However, as the allowable change in the output voltage of the multi-phase voltage regulator circuitry 130 decreases and the current at the output increases, the capacitance of the capacitor 235 needs to increase, which increases cost and system on chip size.

In example operations of the TLVR partition 705 of FIG. 7, the inductors 710, 720 induce a current in the inductors 715, 725 during a pulse of a corresponding PWM signal. The inductors 715, 725 drive the induced current along the current path formed by the inductors 715, 725, 730 to further induce current in the inductors 710, 720. In such example operations, the slope of the current at the output of the multi-phase voltage regulator circuitry 700 is the sum of current through the inductors 710, 720 and the additional current induced by the inductors 715, 725. Advantageously, using the inductors 715, 725 to induce additional current in the inductors 710, 720 increases the slope of rising edges of the current at the output of the multi-phase voltage regulator circuitry 700. Advantageously, increasing the slope of rising edges of the current at the output of the multi-phase voltage regulator circuitry 700 increases response time and power efficiency.

Similarly, if the output current of the multi-phase voltage regulator circuitry 700 is decreasing, the inductors 710, 720 induce less current in the inductors 715, 725. In example operations, decreasing the current through the inductors 710, 720 has the additional effect of decreasing the induced current in the inductors 715, 725. In such example operations, the decrease of current through the inductors 710, 720 and the additional decrease in induced current by the inductors 715, 725 increases the slope of the current at the output of the multi-phase voltage regulator circuitry 700. Advantageously, using the inductors 715, 725 to induce additional current in the inductors 710, 720 increases the slope of falling edges of the current at the output of the multi-phase voltage regulator circuitry 700.

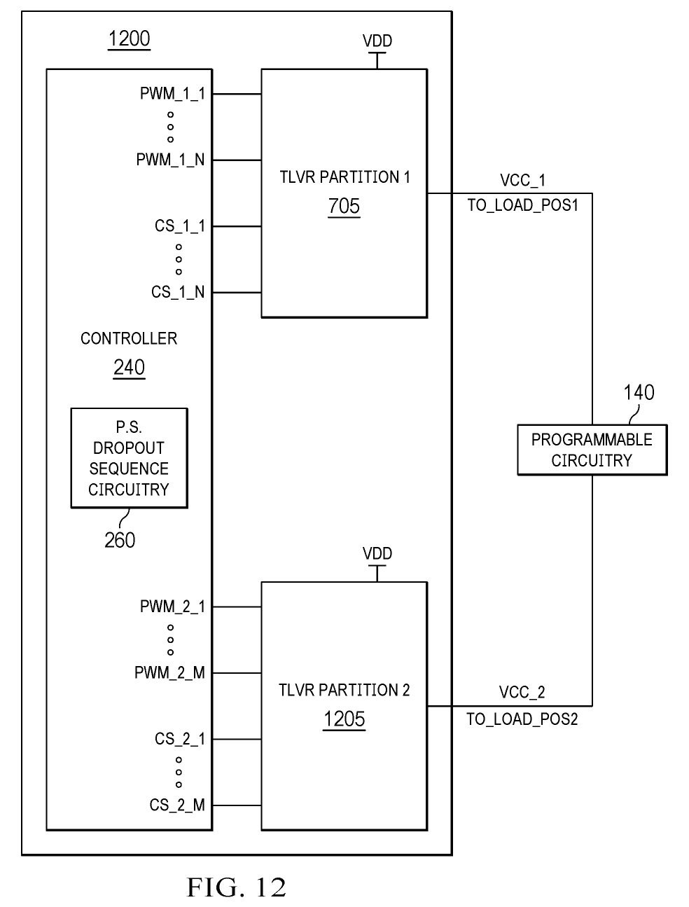

Advantageously, the TLVR partition 705 increases the response time of the current at the output of the multi-phase voltage regulator circuitry 700. Although in the example of FIG. 7 the TLVR partition includes the power stages 205, 215, the TLVR partition 705 may be modified to include any number of power stages and magnetically coupled between the inductors 715, 725. Another example of the multi-phase voltage regulator circuitry 700 using the TLVR partition 705 is further illustrated and described in connection with FIG. 12.

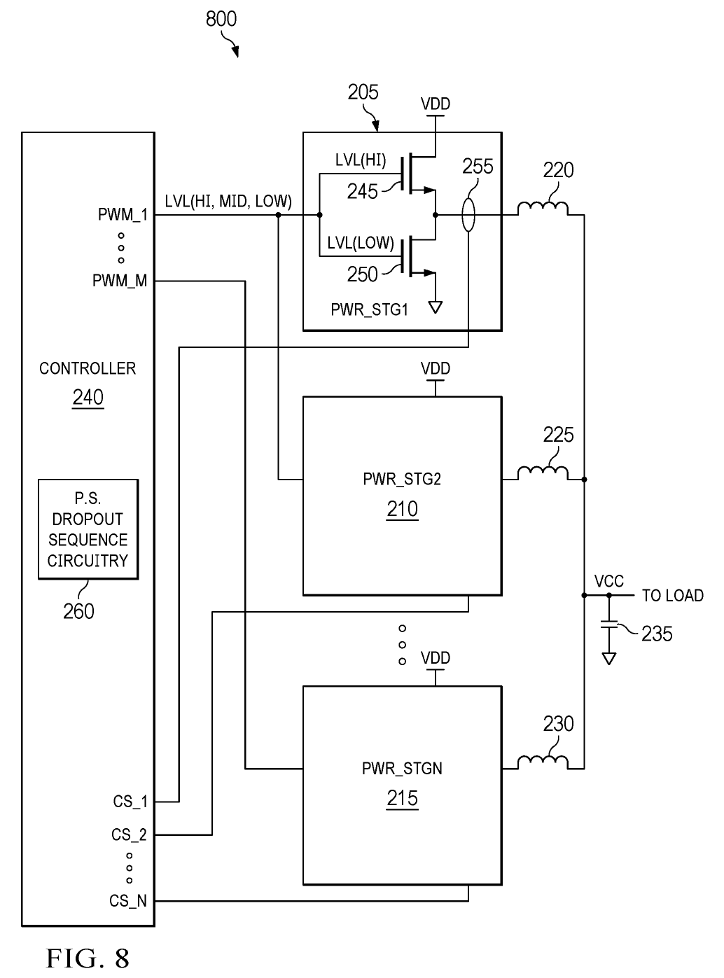

FIG. 8 is a schematic diagram of example multi-phase voltage regulator circuitry 800, which is another example of the multi-phase voltage regulator circuitry 130, 700 of FIGS. 1, 2, and 7. In the example of FIG. 8, the multi-phase voltage regulator circuitry 800 includes the power stages 205, 210, 215, the inductors 220, 225, 230, the capacitor 235, and the controller 240. Unlike in the example of FIG. 2, the controller circuitry 240 has a first output coupled to the power stages 205, 210 and a second output coupled to the power stage 215. In example operations, the controller 240 produces a first PWM signal (PWM_1) to control the power stages 205, 210 and a second PWM signal (PWM_2) to control the power stage 215. In such example operations, if the controller 240 drops the first PWM signal (PWM_1), both of the power stages 210, 215 become inactive.

During phase shedding operations, if the first PWM signal (PWM_1) is kept active during dropout conditions, the multi-phase voltage regulator circuitry 800 provides twice the minimum power. In some examples, to prevent PWM signals that control multiple power stages from remaining active, the controller 240 divides the PWM signals into groups. Each group includes the PWM signals that drive the same number of power stages. For example, in the example of FIG. 8, the controller 240 divides the PWM signals into two groups. The first group includes the PWM signal(s) that control a single power stage, such as the second PWM signal (PWM_2). The second group includes the PWM signal(s) that control two power stages, such as the first PWM signal (PWM_1).

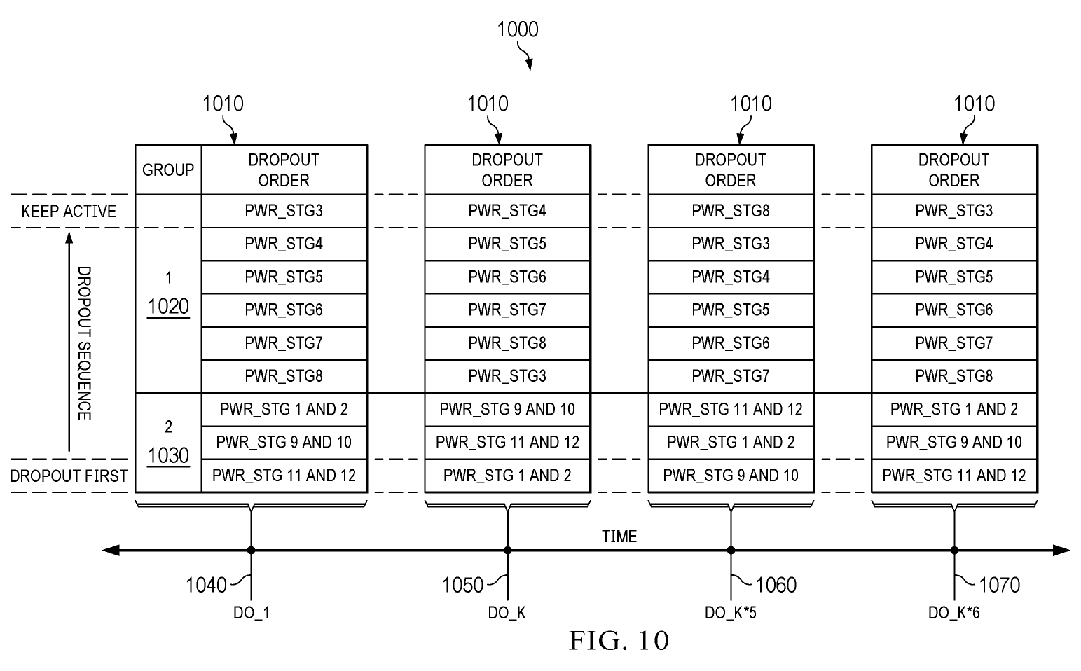

During such phase shedding operations, the controller 240 drops the PWM signals of the second group before disabling PWM signals of the first group. Such an example dropout order is further illustrated and described in connection with FIG. 10. Advantageously, disabling the PWM signals that control multiple power stages before the PWM signals that control a single power stage ensures the minimum power supply of the multi-phase voltage regulator circuitry 800 corresponds to the lowest number of power stages. Advantageously, reducing the minimum power supply of the multi-phase voltage regulator circuitry 800 increases power efficiency.

Alternatively, the controller 240 may group the PWM signals using an alternative scheme. For example, the controller 240 may generate a first group of PWM signals for power stages in proximity to the load and a second group of PWM signals for power stages not in proximity to the load. In such examples, the controller 240 drops out the PWM signals of the second group before the PWM signals of the second group. Advantageously, keeping power stages in proximity to a load active reduces power consumption.

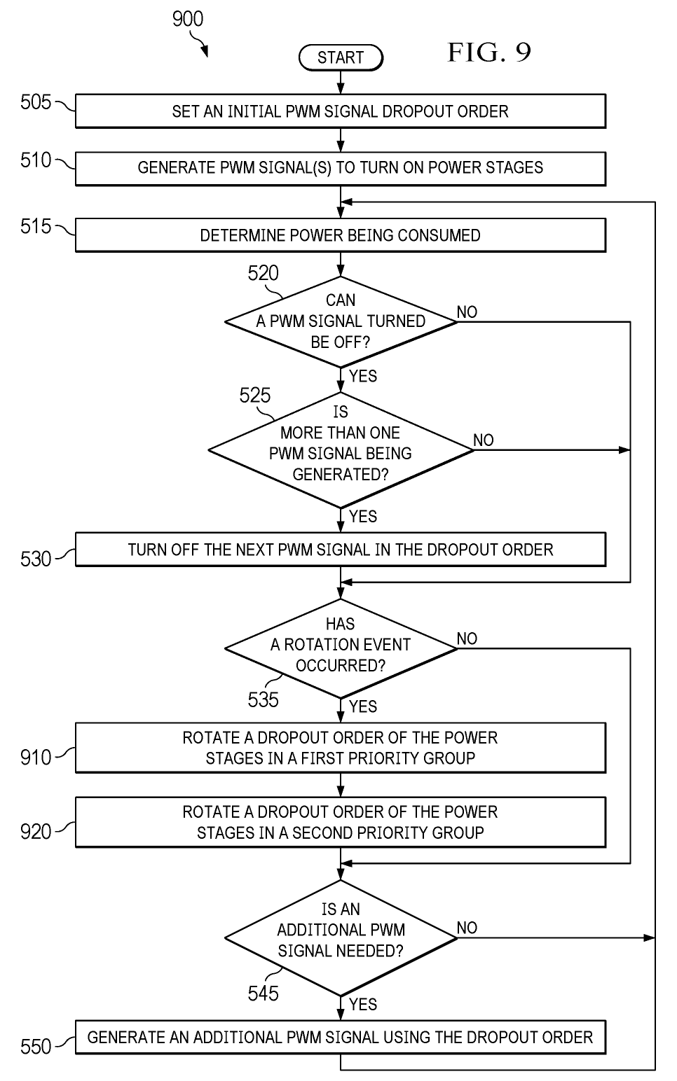

FIG. 9 is a flowchart representative of example machine-readable instructions or example operations 900 that may be at least one of executed, instantiated, or performed using an example implementation of the controller 240 or, more generally, the multi-phase voltage regulator circuitry 800 of FIG. 8 using priority groups. The example operations 900 begin with the operations of Blocks 505, 510, 515, 520, 525, 530, 535. Unlike the example of FIG. 5, the phase drop order circuitry 360 sets a dropout order to have PWM signals of a first group remain active longer than PWM signals of a second group. An example dropout order having two groups is further illustrated and described in connection with FIG. 10.

If the rotation circuitry 350 determines that a rotation event has occurred (e.g., Block 535 returns a result of YES), the rotation circuitry 350 rotates a dropout order of the power stages in a first priority group. (Block 910). Similarly, the rotation circuitry 350 rotates a dropout order of the power stages in a second priority group. (Block 920). In example operations, the phase drop order circuitry 360 is divided into two groups, the first group represents PWM signals that drive a single power stage and the second group represents PWM signals that driver two power stages. In some examples, the phase drop order circuitry 360 includes additional groups corresponding to additional conditions, such as a third group for PWM signals that drive three power stages. In such example operations, the rotation circuitry 350 rotates the PWM signals within each group. For example, if the first group has six PWM signals and the second group has three PWM signals, the rotation circuitry 350 rotates the six PWM signals of the first group separate from a rotation of the three PWM signals of the second group. In such examples, even after a rotation event, the controller 240 drops the three PWM signals of the second group before any of the PWM signals of the first group. Example rotation operations across groups of PWM signals are further illustrated and described in connection with FIG. 10. Control proceeds with the example operations of Blocks 545, 550.

Example methods are described with reference to the flowchart illustrated in FIG. 9. However, many other methods of implementing the controller 240 of FIGS. 2 and 3 or, more generally, the multi-phase voltage regulator circuitry 800 of FIG. 8 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 10 is a timing diagram 1000 of an example rotation of a dropout order 1010 of a plurality of power stages (e.g., the power stages 205, 210, 215). The example dropout order 1010 of FIG. 10 includes a first group dropout order 1020 and a second group dropout order 1030. In the example of FIG. 10, the timing diagram 1000 illustrates changes in the group dropout orders 1020, 1030 or, more generally, the dropout order 1010 across rotation events. The example dropout order 1010 of FIG. 10 illustrates an example dropout order if the multi-phase voltage regulator circuitry 800 includes twelve power stages (e.g., the power stages 205, 210, 215).

The example group dropout order 1020 of FIG. 10 represents power stages of the multi-phase voltage regulator circuitry 800 that the controller 240 controls with individual PWM signals. In the example of FIG. 10, the controller 240 produces six PWM signals to individually control six power stages. In such examples, the controller 240 assigns the six PWM signals to the group dropout order 1020.

The example group dropout order 1030 of FIG. 10 represents power stages of the multi-phase voltage regulator circuitry 800 that the controller 240 controls with a shared PWM signal. In the example of FIG. 10, the controller 240 produces three PWM signals to control six power stages. In such examples, the controller 240 assigns the three PWM signals to the group dropout order 1030.

In the example of FIG. 10, the dropout order 1010 includes the group dropout orders 1020, 1030. Alternatively, the controller 240 may include any number of group dropout orders in the overall dropout order. For example, the controller 240 has a third group for PWM signals controlling three power stages.

At a first time 1040, which is before a first rotation event, the dropout order 1010 is an initial dropout order. During phase shedding operations after the time 1040, the PWM generation circuitry 330 first drops the PWM signal (PWM_11_12) which controls power stages (PWR_STG11 and PWR_STG12). In such examples, the PWM generation circuitry 330 drops the power stages corresponding to the group dropout order 1030 before the power stages of the group dropout order 1020. However, after the time 1040, the PWM generation circuitry 330 continues to generate the PWM signal (PWM_3), which drives the power stage 215 (PWR_STG3), to supply a minimum amount of power. In such example operations, the controller 240 keeps the power stage 215 (PWR_STG3) active to supply the minimum amount of power to a load.

Between the time 1040 and a second time 1050, the controller 240 determines conditions for a rotation event have been met. In example operations, the rotation circuitry 350 rotates PWM signals within the group dropout orders 1020, 1030 responsive to detecting the rotation event. In the example of FIG. 10, the rotation circuitry 350 rotates the group dropout orders 1020, 1030 as separate FIFO queues. Alternatively, another method of rotating the order may be implemented in this description. At the time 1050, the PWM generation circuitry 330 first drops the PWM signal (PWM_1_2) which controls the power stages 205, 210 (PWR_STG1 and PWR_STG2). In such examples, the PWM generation circuitry 330 drops the remaining power stages of the group dropout order 1030 prior to any power stages of the group dropout order 1020.

Between the time 1050 and a third time 1060, the controller 240 determines conditions for multiple rotation events have been met. Between the times 1050, 1060, the rotation circuitry 350 rotates the group dropout orders 1020, 1030 four additional times responsive to four subsequent rotation events. At the time 1060, the group dropout orders 1020, 1030 illustrate the dropout order 1010 five rotation events after the initial dropout order at the time 1040. During phase shedding operations after the time 1060, the PWM generation circuitry 330 first drops the PWM signal (PWM_9_10) which controls power stages (PWR_STG9 and PWR_STG 10).

Between the time 1060 and a fourth time 1070, the controller 240 determines conditions for a rotation event have been met. In example operations, the rotation circuitry 350 rotates the group dropout orders 1020, 1030 responsive to detecting the rotation event prior to the time 1070. Between the times 1040, 1070, the rotation circuitry 350 rotated the group dropout orders 1020, 1030 six times responsive to six rotation events. At the time 1070, the dropout order 1010 returned to the initial dropout order at the time 1040. After the time 1070, the PS dropout circuitry 260 continues to rotate the dropout order 1010.

Advantageously, the controller 240 rotates the power stages within the group dropout orders 1020, 1030. Advantageously, the controller 240 rotates the power stage that is kept active in the group dropout order 1020 to provide the minimum power. Advantageously, rotating the group dropout orders 1020, 1030 spreads out the aging of component use across the power stages (PWR_STG1-PWR_STG12). Advantageously, spreading out the aging of components across the power stages (PWR_STG1-PWR_STG12) reduces mismatch, which increases performance.

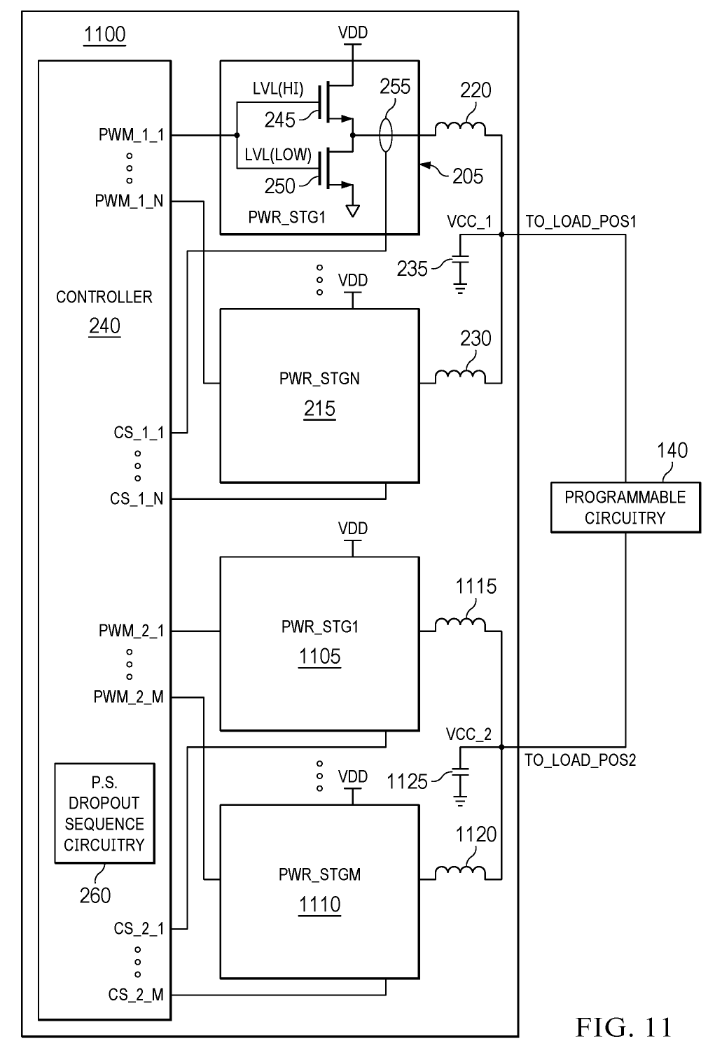

FIG. 11 is a schematic diagram of example multi-phase voltage regulator circuitry 1100, which is another example of the multi-phase voltage regulator circuitry 130, 700, 800 of FIGS. 1, 2, 7, and 8. In the example of FIG. 11, the multi-phase voltage regulator circuitry 1100 includes the power stages 205, 215, the inductors 220, 230, the capacitor 235, the controller 240, a third power stage 1105, a fourth power stage 1110, a third inductor 1115, a fourth inductor 1120, and a second capacitor 1125.

The multi-phase voltage regulator circuitry 1100 has an input, a first output, and a second output. The input of the multi-phase voltage regulator circuitry 1100 is structured to be coupled to a DC power supply, such as the DC-DC regulator circuitry 120. The first output of the multi-phase voltage regulator circuitry 1100 is structured to be coupled to a first position of a load (LOAD_POS1), such as the programmable circuitry 140 of FIG. 1. The second output of the multi-phase voltage regulator circuitry 1100 is structured to be coupled to a second position of the load (LOAD_POS2). The multi-phase voltage regulator circuitry 1100 produces a first DC supply voltage (VCC_1) and a second DC supply voltage (VCC_2) by stepping down an input supply voltage (VDD). The multi-phase voltage regulator circuitry 1100 is structured to provide the first DC supply voltage (VCC_1) to the first position of the programmable circuitry 140. The multi-phase voltage regulator circuitry 1100 is structured to provide the second DC supply voltage (VCC_2) to the second position of the programmable circuitry 140.

The power stage 1105 has a first input, a second input, a first output, and a second output. The first input of the power stage 1105 is coupled to the input of the multi-phase voltage regulator circuitry 1100, which provides the input supply voltage (VDD). The second input of the power stage 1105 is coupled to the controller 240, which provides a PWM signal (PWM_2_1). The first output of the power stage 1105 is coupled to the inductor 1115. The second output of the power stage 1105 is coupled to the controller 240, which receives a current sense signal (CS_2_1).

The power stage 1110 has a first input, a second input, a first output, and a second output. The first input of the power stage 1110 is coupled to the input of the multi-phase voltage regulator circuitry 1100, which provides the input supply voltage (VDD). The second input of the power stage 1110 is coupled to the controller 240, which provides a PWM signal (PWM_2_M). The first output of the power stage 1110 is coupled to the inductor 1120. The second output of the power stage 1110 is coupled to the controller 240, which receives a current sense signal (CS_2_M).

The inductor 1115 has a first terminal and a second terminal. The first terminal of the inductor 1115 is coupled to the power stage 1105. The second terminal of the inductor 1115 is coupled to the inductor 1120, the capacitor 1125, and the second output of the multi-phase voltage regulator circuitry 1100, which supplies the second DC supply voltage (VCC_2).

The inductor 1120 has a first terminal and a second terminal. The first terminal of the inductor 1120 is coupled to the power stage 1110. The second terminal of the inductor 1120 is coupled to the inductor 1115, the capacitor 1125, and the second output of the multi-phase voltage regulator circuitry 1100, which supplies the second DC supply voltage (VCC_2).

The capacitor 1125 has a first terminal and a second terminal. The first terminal of the capacitor 1125 is coupled to the inductors 1115, 1120 and the second output of the multi-phase voltage regulator circuitry 1100, which supplies the second DC supply voltage (VCC_2). The second terminal of the capacitor 1125 is coupled to the common terminal, which provides the common potential.

In example operations, the multi-phase voltage regulator circuitry 1100 provides power to different locations of the programmable circuitry 140. In some examples, the power stages 205, 215, 1105, 1110 are separated to provide power to the different locations of the programmable circuitry 140. In such examples, the controller 240 divides the PWM signals into two groups. The first group includes the PWM signal(s) corresponding to the power stages 205, 215, which produce the first supply voltage (VCC_1). The second group includes the PWM signal(s) corresponding to the power stages 1105, 1110, which produce the second supply voltage (VCC_2).

In example phase shedding operations, similar to the grouping of FIGS. 8, 9, and 10, the controller 240 rotates the PWM signals within the groups. However, unlike in the grouping of FIGS. 8, 9, and 10, the controller 240 keeps at least one power stage in each group active. For example, if the programmable circuitry 140 is in idle, the controller 240 keeps one of the power stages 205, 215 and one of the power stages 1105, 1110 active. In such examples, keeping at least one power stage active in each group ensures the multi-phase voltage regulator circuitry 1100 provides power to both locations of the programmable circuitry 140.

FIG. 12 is a schematic diagram of example multi-phase voltage regulator circuitry 1200, which is another example of the multi-phase voltage regulator circuitry 130, 700, 800, 1100 of FIGS. 1, 2, 7, 8, and 11. Unlike in the example of FIG. 7, the multi-phase voltage regulator circuitry 1200 includes the TLVR partition 705 and a second TLVR partition 1205 to supply power to different locations on the programmable circuitry 140.

The multi-phase voltage regulator circuitry 1200 has an input, a first output, and a second output. The input of the multi-phase voltage regulator circuitry 1200 is structured to be coupled to a power supply, such as the DC-DC regulator circuitry 120. The first output of the multi-phase voltage regulator circuitry 1200 is structured to be coupled to a first position of a load (LOAD_POS1), such as the programmable circuitry 140 of FIG. 1. The second output of the multi-phase voltage regulator circuitry 1200 is structured to be coupled to a second position of the load (LOAD_POS2). The multi-phase voltage regulator circuitry 1200 produces a first supply voltage (VCC_1) and a second supply voltage (VCC_2) by stepping down a supply voltage (VDD). The multi-phase voltage regulator circuitry 1200 is structured to provide the first supply voltage (VCC_1) to the first position of the programmable circuitry 140. The multi-phase voltage regulator circuitry 1200 is structured to provide the second supply voltage (VCC_2) to the second position of the programmable circuitry 140.

The TLVR partition 1205 has a first input, second inputs, a first output, and second outputs. The first input of the TLVR partition 1205 is coupled to the input of the multi-phase voltage regulator circuitry 1200, which provides the supply voltage (VDD). The second inputs of the TLVR partition 1205 are coupled to the controller 240, which provides PWM signals (PWM_2_1, PWM_2_M). The first output of the TLVR partition 1205 is coupled to the second output of the multi-phase voltage regulator circuitry 1200, which supplies the second supply voltage (VCC_2). The second outputs of the TLVR partition 1205 are coupled to the controller 240, which receives current sense signals (CS_2_1, CS_2_M). In the example of FIG. 12, the TLVR partition 1205 is another example of the TLVR partition 705 of FIG. 7.

In example operations, the multi-phase voltage regulator circuitry 1200 provides power to different locations of the programmable circuitry 140. In some examples, the TLVR partitions 705, 1205 are separated to provide power to the different locations of the programmable circuitry 140. In such examples, the controller 240 divides the PWM signals based on the TLVR partitions 705, 1205. The first group includes the PWM signal(s) corresponding to the TLVR partition 705, which produces the first supply voltage (VCC_1). The second group includes the PWM signal(s) corresponding to the TLVR partition 1205, which produces the second supply voltage (VCC_2).

In example phase shedding operations, similar to the grouping of FIGS. 8, 9, and 10, the controller 240 rotates the PWM signals within the groups. However, unlike in the grouping of FIGS. 8, 9, and 10, the controller 240 keeps at least one power stage in each group active. For example, if the programmable circuitry 140 is idle, the controller 240 keeps one power stage of the TLVR partition 705 and one power stage of the TLVR partition 1205 active. In such examples, keeping at least one power stage active in each group ensures the multi-phase voltage regulator circuitry 1200 provides power to both locations of the programmable circuitry 140.

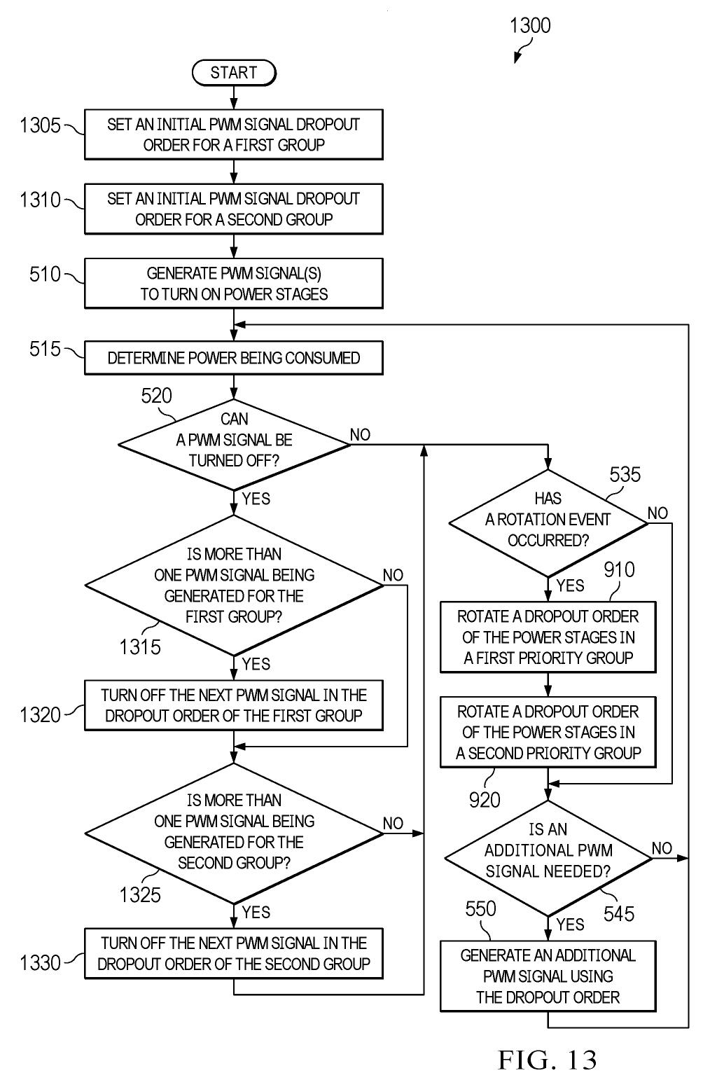

FIG. 13 is a flowchart representative of example machine-readable instructions or example operations 1300 that may be at least one of executed, instantiated, or performed using an example implementation of the controller 240 of FIGS. 2 and 3 or, more generally, the multi-phase voltage regulator circuitry 1100, 1200 of FIGS. 11 and 12.

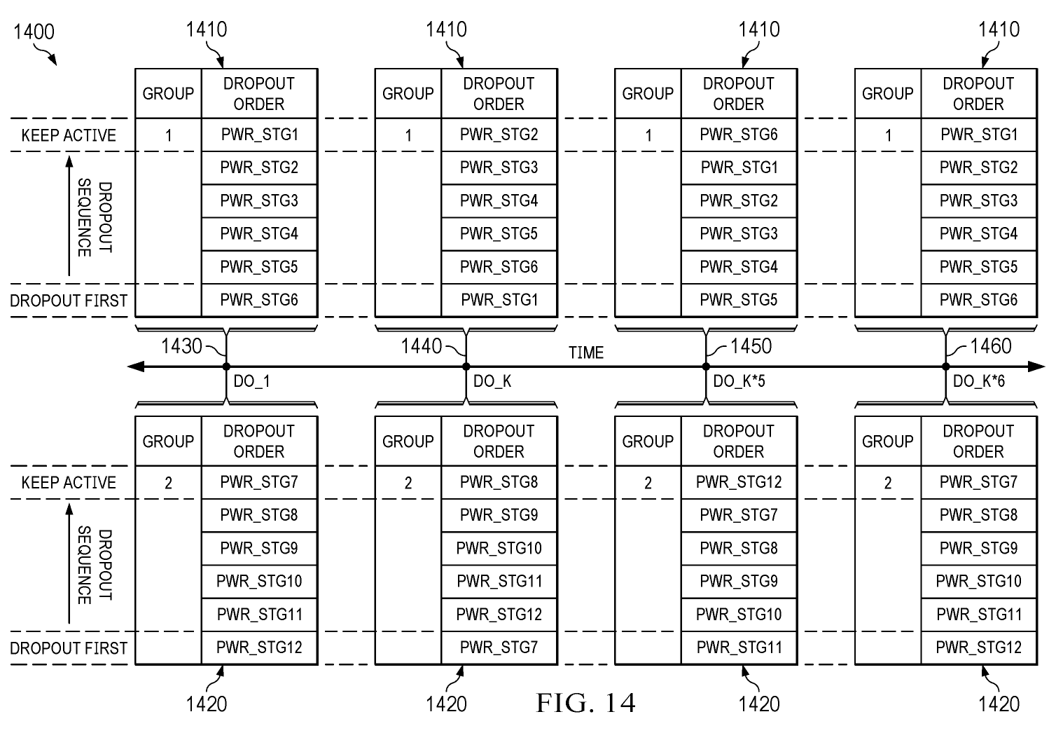

The example operations 1300 begin at Block 1305 at which the phase drop order circuitry 360 determines an initial power stage dropout order for a first group. Similarly, the phase drop order circuitry 360 determines an initial power stage dropout order for a second group. (Block 1310). In example operations, the phase drop order circuitry 360 initializes a first dropout order for the PWM signals (PWM_1_1, PWM_1_N) of a first group and a second dropout order for the PWM signals (PWM_2_1, PWM_2_M) of a second group. For example, the phase drop order circuitry 360 generates two FIFO queues to represent the dropout orders of the first and second groups. In such examples, the phase drop order circuitry 360 sets the initial dropout order responsive to populating the FIFO queues. Examples of the initial group dropout orders are further illustrated and described in connection with FIG. 14. Control proceeds with the example operations of Blocks 510, 515, 520.

If the phase number determination circuitry 320 determines that a PWM signal can be turned off (e.g., Block 520 returns a result of YES), the PWM generation circuitry 330 determines if more than one PWM is being generated for the first group. (Block 1315). In example operations, the PWM generation circuitry 330 determines the number of the PWM signals to generate responsive to the phase number determination circuitry 320. In some examples, such as when the programmable circuitry 140 is idle, the phase number determination circuitry 320 determines that no PWM signals are needed. In such examples, the PWM generation circuitry 330 ensures that the multi-phase voltage regulator circuitry 1100, 1200 are supplying at least a minimum amount of power to a first location of a load at any given time. For example, the PWM generation circuitry 330 ensures that at least one of the PWM signals (PWM_1_1, PWM_1_N) of the first group are being generated.

If the PWM generation circuitry 330 determines that more than one PWM signal is being generated for the first group (e.g., Block 1315 returns a result of YES), the PWM generation circuitry 330 drops the next PWM signal in the dropout order of the first group. (Block 1320). In example operations, the PWM generation circuitry 330 drops at least one of the PWM signals (PWM_1_1, PWM_1_N) of the first group responsive to the determination that more than one of the PWM signals (PWM_1_1, PWM_1_N) are active. In such example operations, the PWM generator circuitry 330 uses the group dropout order for the first group from the phase drop order circuitry 360 to determine which of the PWM signals (PWM_1_1, PWM_1_N) to drops.

If the PWM generation circuitry 330 determines that only one PWM signal is being generated for the first group (e.g., Block 1315 returns a result of NO) or control proceeds from Block 1320, the PWM generation circuitry 330 determines if more than one PWM signal is being generated for the second group. (Block 1325). In example operations, the PWM generation circuitry 330 determines the number of the PWM signals to generate responsive to the phase number determination circuitry 320. In some examples, such as when the programmable circuitry 140 is idle, the phase number determination circuitry 320 determines that no PWM signals are needed. In such examples, the PWM generation circuitry 330 ensures that the multi-phase voltage regulator circuitry 1100, 1200 are supplying at least a minimum amount of power to a second location of a load at any given time. For example, the PWM generation circuitry 330 ensures that at least one of the PWM signals (PWM_2_1, PWM_2_N) of the second group are being generated.

If the PWM generation circuitry 330 determines that more than one PWM signal is being generated for the second group (e.g., Block 1325 returns a result of YES), the PWM generation circuitry 330 drops the next PWM signal in the dropout order of the second group. (Block 1330). In example operations, the PWM generation circuitry 330 drops at least one of the PWM signals (PWM_2_1, PWM_2_M) of the second group responsive to the determination that more than one of the PWM signals (PWM_2_1, PWM_2_M) are active. In such example operations, the PWM generator circuitry 330 uses the group dropout order for the second group from the phase drop order circuitry 360 to determine which of the PWM signals (PWM_2_1, PWM_2_M) to drop. Control proceeds with the example operations of Blocks 535, 545, 550, 910, 920 before returning to Block 515.

Example methods are described with reference to the flowchart illustrated in FIG. 13. However, many other methods of implementing the controller 240 of FIGS. 2 and 3 or, more generally, the multi-phase voltage regulator circuitry 1100, 1200 of FIGS. 11 and 12 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 14 is a timing diagram 1400 of example changes in a first dropout order 1410 of the first group of power stages of FIGS. 11 and 12 and a second dropout order 1420 of the second group of power stages of FIGS. 11 and 12. In the example of FIG. 14, the timing diagram 1400 illustrates changes in the dropout orders 1410, 1420 across rotation events. The example dropout order 1410 of FIG. 14 illustrates an example dropout order if a first group of the multi-phase voltage regulator circuitry 1100, 1200 includes six power stages (PWR_STG1-PWR_STGb). For example, the TLVR partition 705 includes six power stages. The example dropout order 1420 of FIG. 14 illustrates an example dropout order if a second group of the multi-phase voltage regulator circuitry 1100, 1200 includes six power stages (PWR_STG7-PWR_STG12). For example, the TLVR partition 1205 includes six power stages.

At a first time 1430, which is before a first rotation event, the dropout orders 1410, 1420 are initial dropout orders. During phase shedding operations after the time 1430, the PWM generation circuitry 330 first drops the PWM signals (PWM_6, PWM_12) which controls power stages (PWR_STG6 and PWR_STG12). In such examples, the PWM generation circuitry 330 drops the power stages using the dropout orders 1410, 1420. However, after the time 1430, the PWM generation circuitry 330 continues to generate the PWM signals (PWM_1, PWM_7), which drives the power stages (PWR_STG1, PWR_STG7), to supply a minimum amount of power. In such example operations, the controller 240 keeps the power stages (PWR_STG1, PWR_STG7) active to supply the minimum amount of power to each location of a load.

Between the time 1430 and a second time 1440, the controller 240 determines conditions for a rotation event have been met. In example operations, the rotation circuitry 350 rotates PWM signals within the dropout orders 1410, 1420 responsive to detecting the rotation event. In the example of FIG. 14, the rotation circuitry 350 rotates the dropout orders 1410, 1420 as separate FIFO queues. Alternatively, another method of rotating the order may be implemented in this description. At the time 1440, the PWM generation circuitry 330 first drops the PWM signals (PWM_1, PWM_7) which control the power stages (PWR_STG1, PWR_STG7). In such examples, the PWM generation circuitry 330 drops subsequent power stages using the dropout orders 1410, 1420.

Between the time 1440 and a third time 1450, the controller 240 determines conditions for multiple rotation events have been met. Between the times 1440, 1450, the rotation circuitry 350 rotates the dropout orders 1410, 1420 four additional times responsive to four subsequent rotation events. At the time 1450, the dropout orders 1410, 1420 illustrate the dropout orders 1410, 1420 five rotation events after the initial dropout order at the time 1430. During phase shedding operations after the time 1450, the PWM generation circuitry 330 first drops the PWM signals (PWM_5, PWM_11) which control power stages (PWR_STG5, PWR_STG11).

Between the time 1450 and a fourth time 1460, the controller 240 determines conditions for a rotation event have been met. In example operations, the rotation circuitry 350 rotates the dropout orders 1410, 1420 responsive to detecting the rotation event prior to the time 1460. Between the times 1430, 1460, the rotation circuitry 350 rotated the dropout orders 1410, 1420 six times responsive to six rotation events. At the time 1460, the dropout orders 1410, 1420 have returned to the initial dropout order at the time 1430. After the time 1460, the PS dropout circuitry 260 continues to rotate the dropout orders 1410, 1420.

Advantageously, the controller 240 rotates the power stages within the dropout orders 1410, 1420. Advantageously, the controller 240 rotates the power stages that are kept active in each of the dropout orders 1410, 1420. Advantageously, rotating the dropout orders 1410, 1420 spreads out the aging of component use across the power stages (PWR_STG1-PWR_STG12). Advantageously, spreading out the aging of components across the power stages (PWR_STG1-PWR_STG12) reduces mismatch, which increases performance.

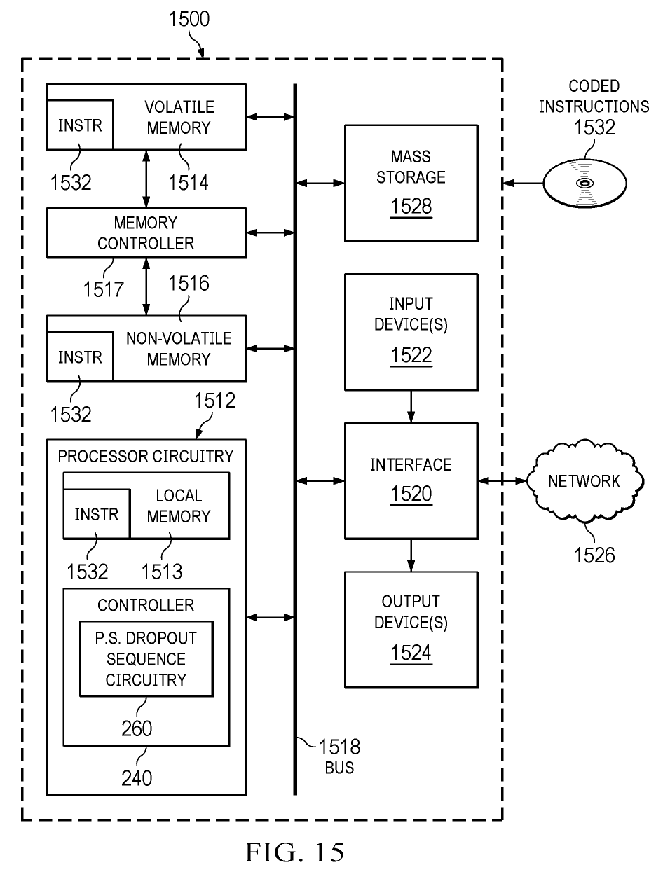

FIG. 15 is a block diagram of an example programmable circuitry platform 1500 structured to one or a combination of execute or instantiate one or more of the example machine-readable instructions or the example operations of FIGS. 5, 9, and 13 to implement the controller 240 of FIGS. 2, 3, 7, 8, 11, and 12. The programmable circuitry platform 1500 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, or microcontrollers from any desired family or manufacturer. The programmable circuitry 1512 may be implemented by one or more semiconductor based (e.g., silicon based) devices. In this example, the programmable circuitry 1512 implements the PS dropout circuitry 260 or, more generally, the controller 240.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1516 may be implemented by one or a combination of flash memory or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter one of or a combination of data or commands into the programmable circuitry 1512. The input device(s) 1522 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1524 are also connected to the interface circuitry 1520 of the illustrated example. The output device(s) 1524 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1520 of the illustrated example, thus, includes one of or a combination of a graphics driver card, a graphics driver chip, or graphics processor circuitry such as a GPU.

The interface circuitry 1520 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store one or more of firmware, software, or data. Examples of such mass storage discs or devices 1528 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1532, which may be implemented by the machine-readable instructions of FIGS. 5, 9, and 13, may be stored in one of or a combination of the mass storage device 1528, in the volatile memory 1514, in the non-volatile memory 1516, or on at least one non-transitory computer readable storage medium such as a CD or DVD which may be removable.

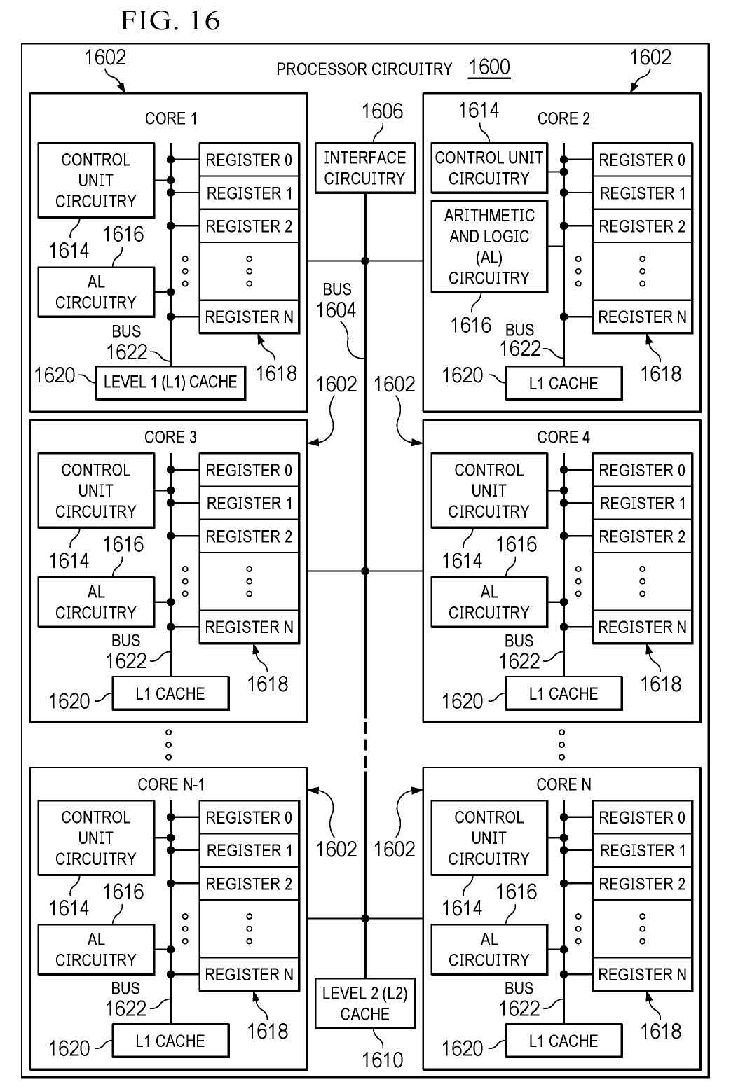

FIG. 16 is a block diagram of an example implementation of the programmable circuitry 1512 of FIG. 15. In this example, the programmable circuitry 1512 of FIG. 15 is implemented by a microprocessor 1600. For example, the microprocessor 1600 may be a general-purpose microprocessor (e.g., general-purpose microprocessor circuitry). The microprocessor 1600 executes some or all of the machine-readable instructions of the flowcharts of FIGS. 5, 9, and 13 to effectively instantiate the circuitry of FIG. 5 as logic circuits to perform operations corresponding to those machine-readable instructions. In some such examples, the circuitry of FIGS. 2, 3, 7, 8, 11, and 12 is instantiated by the hardware circuits of the microprocessor 1600 in combination with the machine-readable instructions. For example, the microprocessor 1600 may be implemented by multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine-readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine-readable instructions or operations represented by the flowcharts of FIGS. 5, 9, and 13.

The cores 1602 may communicate by a first example bus 1604. In some examples, the first bus 1604 may be implemented by a communication bus to effectuate communication associated with one(s) of the cores 1602. For example, the first bus 1604 may be implemented by at least one of an Inter-Integrated Circuit (I2C) bus, a Serial Peripheral Interface (SPI) bus, a PCI bus, or a PCIe bus. Also or alternatively, the first bus 1604 may be implemented by any other type of computing or electrical bus. The cores 1602 may receive data, instructions, and signals from one or more external devices by example interface circuitry 1606. The cores 1602 may output data, instructions, and signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2 cache)) for high-speed access to data and instructions. Data and instructions may be transferred (e.g., shared) by one of or a combination of writing to or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). In some examples, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the local memory 1620, and a second example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic or logic operations on the data within the corresponding core 1602. The AL circuitry 1616 of some examples performs integer-based operations. In other examples, the AL circuitry 1616 also performs floating-point operations. In yet other examples, the AL circuitry 1616 may include first AL circuitry that performs integer-based operations and second AL circuitry that performs floating-point operations. In some examples, the AL circuitry 1616 may be referred to as an Arithmetic Logic Unit (ALU).

The registers 1618 are semiconductor-based structures to store data and instructions such as results of one or more of the operations performed by the AL circuitry 1616 of the corresponding core 1602. For example, the registers 1618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure, such as by being distributed throughout the core 1602 to shorten access time. The second bus 1622 may be implemented by at least one of an I2C bus, a SPI bus, a PCI bus, or a PCIe bus.

Each core 1602 or, more generally, the microprocessor 1600 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1600 is a semiconductor device fabricated to include many transistors interconnected to implement the structures described above in one or more integrated circuits (ICs) contained in one or more packages.

The microprocessor 1600 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on-board the microprocessor 1600, in the same chip package as the microprocessor 1600, or in one or more separate packages from the microprocessor 1600.

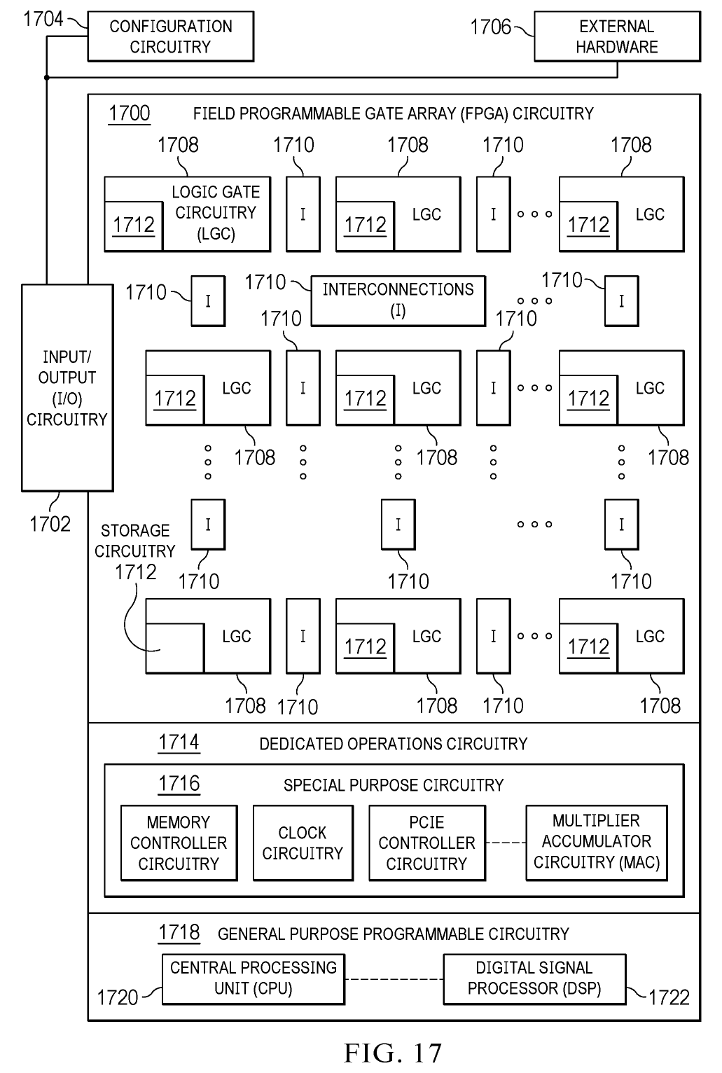

FIG. 17 is a block diagram of another example implementation of the programmable circuitry 1512 of FIG. 15. In this example, the programmable circuitry 1512 is implemented by FPGA circuitry 1700. For example, the FPGA circuitry 1700 may be implemented by an FPGA. The FPGA circuitry 1700 can be used, for example, to perform operations that could otherwise be performed by the example microprocessor 1600 of FIG. 16 executing corresponding machine-readable instructions. However, once configured, the FPGA circuitry 1700 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1600 of FIG. 16 described above (which is a general purpose device that may be programmed to execute some or all of the machine-readable instructions represented by the flowcharts of FIGS. 5, 9, and 13 but whose interconnections and logic circuitry are fixed once fabricated), the FPGA circuitry 1700 of the example of FIG. 17 includes interconnections and logic circuitry that may be one of or a combination of configured, structured, programmed, and interconnected in different ways after fabrication to instantiate, for example, some or all of the operations/functions corresponding to the machine-readable instructions represented by the flowcharts of FIGS. 5, 9, and 13. In particular, the FPGA circuitry 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5, 9, and 13. As such, the FPGA circuitry 1700 may be at least one of configured or structured to effectively instantiate some or all of the operations/functions corresponding to the machine-readable instructions of the flowcharts of FIGS. 5, 9, and 13 as dedicated logic circuits to perform the operations/functions corresponding to those software instructions in a dedicated manner analogous to an ASIC. Therefore, the FPGA circuitry 1700 may perform the operations/functions corresponding to the some or all of the machine-readable instructions of FIGS. 5, 9, and 13 faster than the general-purpose microprocessor can execute the same.

In the example of FIG. 17, the FPGA circuitry 1700 is at least one of configured or structured in response to being programmed (and/or reprogrammed one or more times) based on a binary file. In some examples, the binary file may be one of or both of compiled or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1700 of FIG. 17 may at least one of access or load the binary file to have the FPGA circuitry 1700 of FIG. 17 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1700 of FIG. 17 to at least one of configure or structure the FPGA circuitry 1700 of FIG. 17, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1700 of FIG. 17 may at least one of access or load the binary file to have the FPGA circuitry 1700 of FIG. 17 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1700 of FIG. 17 to at least one of configure or structure the FPGA circuitry 1700 of FIG. 17, or portion(s) thereof.

The FPGA circuitry 1700 of FIG. 17, includes example input/output (I/O) circuitry 1702 to at least one of receive or output data to/from at least one of example configuration circuitry 1704 or external hardware 1706. For example, the configuration circuitry 1704 may be implemented by interface circuitry that may receive a binary file, which may be implemented by one or more of a bit stream, data, or machine-readable instructions, to configure the FPGA circuitry 1700, or portion(s) thereof. In some such examples, the configuration circuitry 1704 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1706 may be implemented by external hardware circuitry. For example, the external hardware 1706 may be implemented by the microprocessor 1600 of FIG. 16.

The FPGA circuitry 1700 also includes an array of example logic gate circuitry 1708, a plurality of example configurable interconnections 1710, and example storage circuitry 1712. The logic gate circuitry 1708 and the configurable interconnections 1710 are configurable to instantiate one or more operations/functions that may correspond to at least some of the machine-readable instructions of FIGS. 5, 9, and 13 and/or other desired operations. The logic gate circuitry 1708 shown in FIG. 17 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of one of or a combination of the electrical structures or the logic gates to form circuits to perform desired operations/functions. The logic gate circuitry 1708 may include other electrical structures such as look-up tables (LUTs), registers (e.g., flip-flops or latches), multiplexers, etc.

The configurable interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example dedicated operations circuitry 1714. In this example, the dedicated operations circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 or an example DSP 1722. Other general purpose programmable circuitry 1718 may also or alternatively be present such as a GPU, an XPU, etc., that can be programmed to perform other operations.

Although FIGS. 16 and 17 illustrate two example implementations of the programmable circuitry 1512 of FIG. 15, many other approaches are contemplated. For example, FPGA circuitry may include an on-board CPU, such as one or more of the example CPU 1720 of FIG. 16. Therefore, the programmable circuitry 1512 of FIG. 15 may also be implemented by combining at least the example microprocessor 1600 of FIG. 16 and the example FPGA circuitry 1700 of FIG. 17. In some such hybrid examples, one or more cores 1602 of FIG. 16 may execute a first portion of the machine-readable instructions represented by the flowcharts of FIGS. 5, 9, and 13 to perform first operation(s)/function(s), the FPGA circuitry 1700 of FIG. 17 may be at least one of configured or structured to perform second operation(s)/function(s) corresponding to a second portion of the machine-readable instructions represented by the flowcharts of FIGS. 5, 9, and 13, and/or an ASIC may be at least one of configured or structured to perform third operation(s)/function(s) corresponding to a third portion of the machine-readable instructions represented by the flowcharts of FIGS. 5, 9, and 13.

Some or all of the circuitry of FIGS. 2, 3, 7, 8, 11, and 12 may, thus, be instantiated at the same or different times. For example, same and/or different portion(s) of the microprocessor 1600 of FIG. 16 may be programmed to execute portion(s) of machine-readable instructions at the same and/or different times. In some examples, same and/or different portion(s) of the FPGA circuitry 1700 of FIG. 17 may be at least one of configured or structured to perform operations/functions corresponding to portion(s) of machine-readable instructions at the same and/or different times.

In some examples, some or all of the circuitry of FIGS. 2, 3, 7, 8, 11, and 12 may be instantiated, for example, in one or more threads executing concurrently and/or in series. For example, the microprocessor 1600 of FIG. 16 may execute machine-readable instructions in one or more threads executing concurrently and/or in series. In some examples, the FPGA circuitry 1700 of FIG. 17 may be at least one of configured or structured to carry out operations/functions concurrently and/or in series. Moreover, in some examples, some or all of the circuitry of FIGS. 2, 3, 7, 8, 11, and 12 may be implemented within one or more virtual machines or containers executing on the microprocessor 1600 of FIG. 16.

In some examples, the programmable circuitry 1512 of FIG. 15 may be in one or more packages. For example, at least one of the microprocessor 1600 of FIG. 16 or the FPGA circuitry 1700 of FIG. 17 may be in one or more packages. In some examples, an XPU may be implemented by the programmable circuitry 1512 of FIG. 15, which may be in one or more packages. For example, the XPU may include a CPU (e.g., the microprocessor 1600 of FIG. 16, the CPU 1720 of FIG. 17, etc.) in one package, a DSP (e.g., the DSP 1722 of FIG. 17) in another package, a GPU in yet another package, and an FPGA (e.g., the FPGA circuitry 1700 of FIG. 17) in still yet another package.

While an example manner of implementing the controller 240 of FIG. 1 is illustrated in FIGS. 2, 3, 7, 8, 11, and 12, one or more of the elements, processes, or devices illustrated in FIGS. 2, 3, 7, 8, 11, and 12 may be combined, divided, re-arranged, omitted, eliminated, or implemented in any other way. Further, the PS dropout circuitry 260 or, more generally, the example controller 240 of FIGS. 2, 3, 7, 8, 11, and 12, may be implemented by hardware alone or by hardware in combination with software and firmware. Thus, for example, any of the PS dropout circuitry 260 or, more generally, the example controller 240, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example controller 240 of FIGS. 2, 3, 7, 8, 11, and 12 may include one or more elements, processes, or devices in addition to, or instead of, those illustrated in FIGS. 2, 3, 7, 8, 11, and 12, or may include more than one of any or all of the illustrated elements, processes and devices.

Flowcharts representative of example machine-readable instructions, which may be executed by programmable circuitry to at least one of implement or instantiate the controller 240 of FIGS. 2, 3, 7, 8, 11, and 12 or representative of example operations which may be performed by programmable circuitry to at least one of implement or instantiate the controller 240 of FIGS. 2, 3, 7, 8, 11, and 12, are shown in FIGS. 5, 9, and 13. The machine-readable instructions may be one or more executable programs or portion(s) of one or more executable programs for execution by programmable circuitry such as the programmable circuitry 1512 shown in the example processor platform 1500 described below in connection with FIG. 15 and may be one or more function(s) or portion(s) of functions to be performed by the example programmable circuitry (e.g., an FPGA) described below in connection with FIGS. 16 or 17. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5, 9, and 13, many other methods of implementing the example controller 240 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to have them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5, 9, and 13 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/- 10 % unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function /or other additional or alternative functions. The configuring may be through at least one of firmware or software programming of the device, through at least one of a construction or layout of hardware components and interconnections of the device, or a combination thereof.

A device or component that is “capable of” performing a task or function includes at least one of a program or hardware that may be or already is configured to perform the task or function. The configuration may be at a time of manufacturing by a manufacturer, by a user after manufacturing, by firmware, or by software.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/- 10 percent of the stated value, or, if the value is zero, a reasonable range of values around zero.

Modifications are possible in the described embodiments, and other embodiments are possible, within the scope of the claims.

What is claimed is:

1. An apparatus comprising:
current monitor circuitry capable of determining a power consumption;
pulse width modulation (PWM) generation circuitry capable of generating a plurality of PWM signals having different phases; and
dropout circuitry coupled to the current monitor circuitry and the PWM generation circuitry, the dropout circuitry capable of:
generating a dropout order of the plurality of PWM signals;
detecting a rotation event using the power consumption; and
adjusting the dropout order of the plurality of PWM signals responsive to the rotation event.

2. The apparatus of claim 1, further comprising phase number determination circuitry coupled to the current monitor circuitry and the PWM generation circuitry, the phase number determination circuitry capable of determining a number of PWM signals to generate responsive to the power consumption.

3. The apparatus of claim 1, wherein the dropout circuitry is further capable of:
comparing the power consumption to a threshold power consumption;
counting a number of times the power consumption is less than the threshold power consumption; and
generating the rotation event responsive to the count being greater than or equal to a threshold count.

4. The apparatus of claim 1, wherein the dropout order is a first dropout order, the first dropout order corresponds to a first portion of the plurality of PWM signals, the dropout circuitry further capable of:
generating a second dropout order corresponding to a second portion of the plurality of PWM signals; and
adjusting the second dropout order responsive to the rotation event.

5. The apparatus of claim 4, wherein the PWM generation circuitry is further capable of:
turning off the second portion of the PWM signals using the second dropout order; and
after turning off the second portion of the PWM signals, turning off the first portion of the PWM signals using the first dropout order.

6. The apparatus of claim 4, wherein the PWM generation circuitry is further capable of:
turning off the first portion of the PWM signals using the first dropout order;
keeping on one of the first portion of the PWM signals using the first dropout order;
turning off the second portion of the PWM signals using the second dropout order; and
keeping on one of the second portion of the PWM signals using the second dropout order.

7. The apparatus of claim 1, wherein the plurality of PWM signals includes a first PWM signal and a second PWM signal, the first PWM signal having a first phase, the second PWM signal having a second phase, and the apparatus further comprising:
a first power stage capable of supplying a first voltage responsive to the first phase of the first PWM signal; and
a second power stage capable of supplying a second voltage responsive to the second phase of the second PWM signal.

8. The apparatus of claim 7, further comprising:
a first inductor coupled to the first power stage, the first inductor capable of producing a first current responsive to the first voltage;
a second inductor coupled to the second power stage, the second inductor capable of producing a second current responsive to the second voltage; and
programmable circuitry coupled to the first inductor and the second inductor, the programmable circuitry capable of executing a workload using power from the first current and the second current.

9. An apparatus comprising:
a first power stage;
a second power stage; and
a controller coupled to the first power stage and the second power stage, the controller capable of:
sensing a power supply by the first power stage and the second power stage;
comparing the power supplied by the first power stage and the second power stage to a threshold;
disabling the first power stage based on a dropout order responsive to the comparison; and
adjusting the dropout order responsive to power supplied by the first power stage and the second power stage.

10. The apparatus of claim 9, wherein the controller is further capable of:
providing a first PWM signal to the first power stage, the first PWM signal having a first phase;
providing a second PWM signal to the second power stage, the second PWM signal having a second phase; and
disabling the one of the first power stage or the second power stage using the dropout order and one of the first PWM signal or the second PWM signal.

11. The apparatus of claim 9, wherein controller is further capable of:
counting a number of times the power supply is less than a minimum; and
generating a rotation event responsive to the count being greater than or equal to a threshold count.

12. The apparatus of claim 9, wherein the dropout order is a first dropout order, the first dropout order corresponds to a first set of PWM signals, the controller is further capable of:
generating a second dropout order corresponding to a second set of PWM signals; and
adjusting the second dropout order responsive to a rotation event.

13. The apparatus of claim 12, wherein the controller is further capable of:
turning off the second set of PWM signals using the second dropout order; and
after turning off the second set of PWM signals, turning off the first set of PWM signals using the first dropout order.

14. The apparatus of claim 12, wherein the controller is further capable of:
turning off the first set of PWM signals using the first dropout order;
providing at least one PWM signal of the first set of PWM signals using the first dropout order;
turning off the second set of PWM signals using the second dropout order; and
providing at least one PWM signal of the second set of PWM signals using the second dropout order.

15. The apparatus of claim 9, further comprising:
a first inductor coupled to the first power stage, the first inductor capable of producing a first current responsive to a first voltage from the first power stage;
a second inductor coupled to the second power stage, the second inductor capable of producing a second current responsive to a second voltage from the second power stage; and
programmable circuitry coupled to the first inductor and the second inductor, the programmable circuitry capable of executing a workload using power from the first current and the second current.

16. An apparatus comprising:
pulse width modulation (PWM) generation circuitry capable of generating a first group of PWM signals and a second group of PWM signals; and
dropout circuitry coupled to the PWM generation circuitry, the dropout circuitry capable of:
generating a first dropout order of the first group of PWM signals;
generating a second dropout order of the second group of PWM signals;
adjusting the first dropout order of the first group of PWM signals responsive to a rotation event; and
adjusting the second dropout order of the second group of PWM signals responsive to a rotation event.

17. The apparatus of claim 16, further comprising:
current monitor circuitry capable of determining a power consumption; and
phase number determination circuitry coupled to the current monitor circuitry and the PWM generation circuitry, the phase number determination circuitry capable of determining a number of PWM signals to generate responsive to the power consumption.

18. The apparatus of claim 16, wherein the PWM generation circuitry is further capable of:
turning off the second group of PWM signals using the second dropout order; and
after turning off the second group of PWM signals, turning off the first group of PWM signals using the first dropout order.

19. The apparatus of claim 16, wherein the PWM generation circuitry is further capable of:
turning off the first group of PWM signals using the first dropout order;
providing at least one PWM signal of the first group of PWM signals using the first dropout order;
turning off the second group of PWM signals using the second dropout order; and
providing at least one PWM signal of the second group of PWM signals using the second dropout order.

20. The apparatus of claim 16, further comprising:
a first power stage capable of supplying a first voltage responsive to a first PWM signal of the first group of PWM signals;
a second power stage capable of supplying a second voltage responsive to a second PWM signal of the second group of PWM signals;
a first inductor coupled to the first power stage, the first inductor capable of producing a first current responsive to the first voltage;
a second inductor coupled to the second power stage, the second inductor capable of producing a second current responsive to the second voltage; and
programmable circuitry coupled to the first inductor and the second inductor, the programmable circuitry capable of executing a workload using power from the first current and the second current.
